(19) United States
(12) Patent Application Publication
(10) Pub. No.: US 2007/0002267 A1
(43) Pub. Date: Jan. 4, 2007

(54) Liquid crystal display device

(75) Inventor: Akihiro Mochizuki, Louisville, CO (US)

Correspondence Address: Barry E. Bretschneider;Morrison & Foerster LLP, Suite 300, 1650 Tysons Boulevard, McLean, VA, 22102, US

(73) Assignee: Nano Loa, Inc., Kawasaki-shi (JP)

(21) Appl. No.: 11/168,923

(22) Filed: Jun. 29, 2005

(51) Int. Cl. C09K 19/02

(52) U.S. Cl. 349/184

(57) ABSTRACT

A liquid crystal device comprising: at least a pair of substrates; and a Smectic phase liquid crystal material disposed between the pair of substrate. The molecular long axis or n-director of the Smectic phase liquid crystal material has a tilt angle to its layer normal as a bulk material, and the molecular long axis of the Smectic phase liquid crystal material aligns parallel to the pre-setting alignment direction, resulting in its long axis layer normal.

### BACKGROUND OF THE INVENTION

1. Field of the Invention

The present invention relates to a liquid crystal display device, particularly to a display device suitable for full motion video image, employing a Polarization Shielded Smectic (hereinafter, referred to as “PSS”) liquid Crystal or a PSS liquid crystal material.

2. Related Background Art

Recent increase in application field of liquid crystal displays (LCDs) shows many varieties such as the advanced cell phone displays, net personal digital assistance (PDA), computer monitors, and large screen direct view TVs. These emergent increases in application field are based on recent LCDs improvement in their performance and in their manufacturability.

On the other hand, new flat panel display technologies such as Organic Light Emission Displays (OLEDs), Plasma Display Panels (PDPs) have been accelerated in their development and manufacturing to compete with LCDs. Moreover, introduction to new application field of LCDs requests new and higher performance to meet with these new application fields. In particular, most of recent emergent application fields require full-color motion video image, which is still difficult to conventional LCD technology, in terms of slow response nature of conventional LCDs and their narrow viewing angle in nature.

Under the above given circumstances, LCDs are being required higher performance, in particular faster optical response in order to expand their application field competing with new flat panel display technologies which all have faster optical response performance than current LCD technologies. Followings are detail descriptions of concrete desirable performances at each particular application field to new LCD technologies.

(Technical Problems of Current LCD Technologies in Each Application Field)

(Advanced Cell Phone Application and Related Applications)

Thanks to recent infrastructure improvement in broad band system availability, in some countries such as Korea, Japan and Norway already have commercial service of broad band to cell phones. This dramatic increase of transmittance capacity enables cell phone to treat full-color motion video image. Moreover in conjunction with wide spread of image capturing device, such as Charge Coupling Device (CCDs), Complimentary Metal Oxide Semiconductor Sensors (CMOS Sensors), the latest cell phones in above countries are changing from “talking” device to “watching” device very rapidly. This “watching” function of the advanced cell phone is not limited in full motion video image, but also for internet browsing which is required much higher resolution to the cell phone displays.

For this particular demand, conventional LCDs based on Thin Film Transistor (TFT) technology (hereinafter, referred to as “TFT-LCDs”) has proven its performance of full motion video image capability in relatively large size panel displays such as over 6 inch diagonal screen size. Emergent competition with OLEDs in this particular application field, one of the advantages of LCD technology general is its high balance between brightness of screen and image retention and life time.

For all of display technologies, more or less, this relationship between screen brightness and image retention, life time is always tradeoff. Due to emissive nature of phosphor in OLEDs, this tradeoff is much severe than that of LCDs. One of the beautiful points of conventional TFT-LCDs is its free relationship between screen brightness and life time of LCD itself. Because conventional LCDs are all light switching device and non-emissive device, so that LCDs are free from this tradeoff. Current TFT-LCDs life time is most decided by backlight itself. Therefore, for cell phone, Net PDA, those are required in outdoor use; prefer to use longer life brighter displays that are LCD base displays.

Current TFT-LCDs technical problem to meet with those advanced display application required full color motion video image is its poor resolution at small display screen size as well as its slow optical response, which is a critical requirement for “watching” cell phone and other carrying device.

In general, the minimum required resolution for natural TV screen image needs Quarter Video Graphic Array (QVGA: 320×240 pixels) at least. Based on conventional TFT-LCD technology using Red, Green and Blue (RGB) micro color filter (see following description and FIG. 1.) on sub-pixel, actual required number of pixel element is (240×3)×320 pixels. In current commercially available displays for the advanced cell phone limited screen size of 2.5 inches diagonal have up to Quarter Video Graphic Array (QVGA: (240×3)×320 pixels), which is not enough to show TV image on the screen. In particular, a portrait screen use at cell phones and Net PDAs, pixel arrangement resolution is more complicated than that for other applications using as a landscape screen use.

FIG. 1 presents current RGB sub-pixel structure in TFT-LCDs. Each micro color filter on each sub-pixel works as one of primary color element at the TFT-LCD. Due to very fine pitch pattern of these physically separated primary color elements, human eye recognizes mixed color image. Each sub-pixel switches light from backlight to pass through its own primary color. Spatially divided primary color is required to keep rectangular sub-pixel shape to keep square image by RGB sub-pixel combination. The following Table 1 shows both sub-pixel and pixel pitches depending on screen diagonal size with QVGA resolution.

TABLE 1
Sub pixel pitch depending on screen size at QVGA resolution

| Screen diagonal size | Sub-pixel pitch | Pixel Pitch |
|---|---|---|
| (inch) | (μm) | (μm) |
| 10 | 211.7 | 635 |
| 5 | 95.4 | 286 |
| 2.5 | 52.9 | 159 |
| 1.25 | 26.4 | 79.3 |

This table clearly presents that 10 inches diagonal screen size with QVGA resolution provides enough design width in TFT array substrate, however, 2.5 inches diagonal screen with QVGA has only 53 μm pitch, which is not enough compared to conventional design rule of 4 μm of TFT array.

This extremely tight design width provides two major problems. One is reduction of aperture ratio; the other is manufacturing yield reduction due to tight mask alignment registration. Aperture ratio reduction is a critical problem for cell phone, Net PDA those are driven by battery. Smaller aperture ratio means less efficiency of backlight throughput.

In conclusion, advanced cell phone displays and Net PDA applications those are required small screen size with higher resolution as well as fast enough full motion video image without sacrificing power consumption, need higher resolution keeping with high enough aperture ratio, in addition to fast enough optical response for higher quality full motion video image reproductivity.

(Large Screen Direct View LCD TV Application)

It is now well known that flat panel display technologies such as LCDs and PDPs are rapidly cutting into home use large screen TV market, which used to be dominated by Cathode Ray Tube (CRT) technology both in direct view and projection display. In general, one of the advantages of TFT-LCDs compared to PDPs for this particular application field is its higher resolution and its fine image quality. Due to this advantage, TFT-LCD base TVs are now developing their market share at the CRT dominated screen size market, which is between 20 inches to 36 inches diagonal. On the other hand, PDPs which has some difficulty in fine pitch pixel patterning, but has advantages in manufacturing for larger panel size than that of TFT-LCDs are focusing on industrial use of over 60 inches diagonal screen TVs.

TFT-LCDs have already established large market in computer monitor screen both for laptop and desk top computers such as 12 inches to 20 inches diagonal. Image performance required in computer monitor and TV is very different, though. Screen brightness required to computer monitor displays is limited such as 150 cd/m2 or less due to its use in close eye distance. Text oriented display image content of computer monitor displays allows substantial 32 to 64 gray shades color reproduction, instead of 256 gray shades or more gray shades for full color motion video image reproduction.

For large screen direct view TV applications, particularly over 20 inches diagonal TV screens, screen brightness, contrast ratio, full-color gray shades, and viewing angle are very important to provide good enough image quality as TV image. In particular, larger screen TVs such as over 30 inches diagonal, its image quality is expected much like cinema image quality which is extremely important to have deeper gray shades such as 512 gray shades or more without showing image blur. Required resolution for direct view TVs are such as VGA (640×480 pixels) for National Television Standard Code (NTSC), higher resolution for Wide Extended Graphic Array (WXGA: 1,280×768 pixels), and full standard for high definition TV (HDTV: 1,920×1,080 pixels).

In large screen direct view TV applications, there is very distinct difference with small high resolution display application. This difference is based on screen image velocity issue.

When two screen images are compared between 20 inches and 40 inches diagonal both have WXGA resolution, screen diagonal distance of 20 inches is half of that of 40 inches. However, screen frame frequency as TV image is same between 20 and 40 inches screen. This provides image velocity difference as shown in FIG. 2. The screen image velocity is simply in proportion to diagonal size. When total resolution is the same like WXGA, pixel element size of 40 inches diagonal screen has four times larger than that of 20 inches diagonal screen. Larger pixel is more perceptible than smaller pixel size. In particular, relatively slow optical response of conventional TFT-LCDs is much more perceptible in larger pixel size, which is larger screen size. This requests faster optical response at each pixel element in larger diagonal screen panel than that in smaller diagonal screen panel to avoid perceptible slow optical response, which is fatal problem in TV image quality.

In CRT base TV image, phosphor emission at each pixel element is extremely fast such as several micro second compared to conventional TFT-LCDs, so that regardless screen diagonal size, screen image velocity depending on screen diagonal size is far beyond human eye time resolution perceptive. However, optical response at conventional TFT-LCDs is typically several tens of milliseconds, and inter gray scale optical response time is couple of hundreds milliseconds. Because, typical human eye time resolution is said that hundred milliseconds, so that conventional TFT-LCDs slow optical response time is perceptive enough for human eyes. Therefore, large screen direct view TVs using conventional TFT-LCD technology has significant problem in terms of reproduction of natural TV image familiar with CRT base TV image for most human eyes.

Other image quality problem in conventional TFT-LCD TV is its image blur. This image blur is not from slow optical response of TFT-LCD, but from its frame response. CRT base TV uses very short but very strong emission in a frame. This emission time from phosphor is such as several microseconds in a frame time of 16.7 milliseconds for 60 Hz of frame rate. This short but extremely strong emission gives some sort of impact to human eyes, resulting in whole frame image in human eyes. On the contrary, conventional TFT-LCD image keeps same brightness level in the period of whole frame. In a very rapid movement image, this holding type brightness in a period of whole frame makes image blur. Cinema image based on film had same image blur problem. Now cinema image uses mechanical shuttering to make blanking in order to avoid this image blur.

(Other Applications Required Full Color Video Image)

As mentioned above, most of recent applications of TFT-LCDs require full color video image. Not only TV application, Digital Versatile Discs (DVDs), gaming monitors, computer monitor displays also make fusion with TV image. Although actual required image quality is very dependent on screen diagonal size, particularly for TV image case, CRT equivalent TV image quality is absolutely required for all of full motion video image applications. In this very clear requirement, conventional TFT-LCDs have significant problem in their optical response time, in particular, inter gray scale response as mentioned above.

Moreover, image blur due to constant brightness in a period of a frame makes TFT-LCDs difficult to apply to TV image applications. Although some trial to reduce this fatal image blur problem in TFT-LCDs by inserting backlight blanking described in International Display Workshop in Kobe, “Consideration on Perceived MTF of Hold Type Display for Moving Image”; pp. 823-826, (1998), T. Kurita, et. al. This method makes backlight life time short, which is current dominant factor to decide TFT-LCD life time. As TV application, shortening backlight life time due to this blanking, degrades TFT-LCD TV value significantly.

(Technical Issue)

Technical problems to be solved by new technology are somewhat dependent on actual application field. For each particular application field, following shows particular technical problem required to be solved at each application. However, the principle technology solving above requirements is common based on the enhancement of liquid crystal molecular alignment at the PSS-LCDs. The PSS-LCD or the polarization shielded Smectic liquid crystal displays have been invented as described at the United States patent application US-2004/0196428 A1. The concept and purpose of this technology are to provide the most fundamental method to obtain the liquid crystal molecular alignment of the PSS-LCD, in terms of realizing higher display performance and/or higher manufacturability or higher manufacturing yield.

(Small Screen High Resolution Displays)

As described in previous section, conventional micro color filter TFT-LCD has significant difficulty in its applicability for this particular application due to significant low aperture ratio and lower manufacturing yield based on smaller pixel pitch. Field sequential color method has been known as an effective way to keep high aperture ratio in small screen size with high resolution displays.

A couple of papers on field sequential color displays such as International Workshop on Active Matrix Liquid Crystal Displays in Tokyo (1999), “Ferroelectric Liquid Crystal Display with Si Backplane”; A. Mochizuki, pp. 181-184, ibid; “A Full-color FLC Display Based on Field Sequential Color with TFTs”, T. Yoshihara, et. al, pp. 185-188 describe advantages of field sequential color method in detail.

As described in these papers, field sequential color uses same one pixel to-represent Red, Green, and Blue colors in time sequentially. Fast optical response to realize field sequential color is the most important in this system. In order to have natural color image without showing color breaking, at least three times faster optical response in liquid crystal switching is required to have 3× frame rate than conventional micro color filter color reproduction.

Conventional Twisted Nematic (TN) liquid crystal drive mode, which is the most popular and current dominant drive mode, does not have enough optical switching response to satisfy this 3× frame rate. Thus, new fast optical response liquid crystal drive mode is necessary to realize the field sequential color display. As long as we could have fast optical response drive mode, field sequential color display realizes both high aperture ratio and high resolution as shown in FIG. 3, which provides bright, high resolution, and fast enough optical response for the advanced cell phone displays with lower power consumption.

The field sequential color display system has been introduced using Nematic liquid crystal, Surface Stabilized Ferroelectric Liquid Crystal (SSFLC) in conjunction with silicon backplane, and TFT driven ferroelectric liquid crystal which shows analog gray scale. The Nematic liquid crystal used field sequential color display has extremely thin panel gap of 2 μm as Nematic LCD. This realizes 180 Hz frame rate response of the liquid crystal. This system enables both high aperture ratio and high resolution as described in Denshi Gijyuts July, 1998 in Tokyo “Liquid crystal fast response technology and its application”; M. Okita, pp. 8-12 (in Japanese).

However, this system could not fully use advantage of high aperture ratio due to the nature of TN optical response profile as shown in FIG. 4(a). There is very big difference in backlight throughput efficiency between conventional color filter with continuous emitting white backlight and field sequential color system. In conventional color system, aperture ratio of the panel directly represents light throughput and image quality. However, in field sequential color system, light throughput and image quality such as contrast ratio, color purity are decided as combination properties between liquid crystal optical response profile and backlight emission timing.

FIGS. 4(a) and 4(b) show very simple difference in light throughput between symmetrical and asymmetrical optical response profiles in rise and fall. As these figures show the difference, light throughput of field sequential color display is decided by both liquid crystal optical response profile and backlight emission timing. Due to long tail nature of fall profile in TN-LCD, most of backlight emission at fall edge is not used as display. On the contrary, FIG. 4(b) case using symmetrical response profile both rise and fall edges, most of backlight emission is fully used as display. Therefore, in field sequential color display, high aperture ratio is not enough to keep low power consumption, or bright screen. Symmetrical response profile to maximize use of backlight emission is necessary to keep bright screen with low power consumption.

Moreover, FIG. 4(a) and 4(b) present that long tail fall profile has possible color contamination, if the tail reaches at next frame backlight emission. This case easily happens at lower temperature range where TN optical response shows significant slow one due to increase of viscosity of liquid crystal. In this case, due to light leakage at “black” level, significant contrast ratio reduction happens at the same time with color mixing. Thus, in order to obtain high performance filed sequential color display, both fast optical response and symmetrical response profile are necessary.

This properties are actually realized by conventional SSFLCD and analog gray scale capable FLCD. The conventional SSFLCD has no analog gray scale capability, so that TFT array could not provide full color video image due to limited electron mobility of the TFTs. Silicon backplane provides enough electron mobility to drive SSFLCD as pulse width modulation, so that full color video image is possible.

However, due to economical reason, silicon backplane is difficult to apply to direct view large screen display in conjunction with difficulty in front lit lighting system in enough brightness. Analog gray scale capable FLC such as Polymer Stabilized V-shaped Ferroelectric Liquid Crystal Display (PS-V-FLCD) described by Japanese Journal of Applied Physics; “Preliminary Study of Field Sequential Full color Liquid Crystal Display using Polymer Stabilized Ferroelectric Liquid Crystal Display”; Vol. 38, (1999) L534-L536; T. Takahashi, et. al., shows same electro-optical response with TN-LCD. Here, the “V-shaped” is designated as an analog gray scale capability controlled by applied electric field strength. In the applied voltage (V) and transmittance (T) relationship, the analog gray scale LCD shows “V-shaped”, so that hereinafter, the word “V-shaped” is equivalent with analog gray scale capability controlled by the applied electric field strength. Note that in physical, the V-shaped optical response means non-threshold or thresholdless in its voltage and transmittance curve.

Thus it would be applicable for small screen with high resolution display application. This system, however, requires photo-polymerization process by UV light. The UV exposure process has risk to provide decomposition of liquid crystal itself. In order to avoid liquid crystal decomposition at the UV exposure process, very strict control in process is required. In most of actual TFT-LCDs, there is a metal area in the array, which does not pass through UV light. This makes difficult to have complete UV polymerization. Moreover, the physical meaning of the V-shaped is no-threshold in its voltage-transmittance curve (V-T curve), which is not practical in actual application, in particular TFT driven LCDs that have threshold voltage variation in their TFTs. For practical application, current conventional TFTs require to have a certain amount of threshold voltage in the liquid crystal drive mode. Therefore, non-threshold or V-shaped response is not practically applicable to the TFT drive device.

In conclusion, an ideal small and high resolution display for advanced cell phone is analog gray scale capable with both rise/fall fast optical response profile shown in the PSS-LCDs as described in US patent application “US-2004/0196428 A1”.

(Large Screen Direct View TV Application)

In large screen direct view TV application, it has been described that increase in screen size requires increase in image velocity. The increase in image velocity needs decrease in liquid crystal optical response time at each pixel element. In economical point of view, regardless liquid crystal technologies, it is extremely important to use current existing large panel manufacturing line without necessity of introducing entirely new manufacturing equipment. This also means that regardless liquid crystal technologies, most of current existing manufacturing process is applicable for stable and well controlled production process. Therefore, fast response new liquid crystal drive mode should fit for current standard micro color filter TFT array process. The conventional SSFLCD is superior in its extremely fast optical response, however, this has no capability in analog gray scale response. Due to no analog gray scale capability, the conventional SSFLCD is not able to be driven by conventional micro color filter TFT array.

The Polymer Stabilized V-shaped FLCD which has analog gray scale capability potentially fits for current existing volume production line and process. One restriction of Polymer Stabilized V-shaped FLCD in terms of availability of current volume production line and process is applied voltage through TFT array. Mainly in economical reason, maximum applied voltage to each pixel is limited to 7V. Using polymer with FLC material at Polymer Stabilized V-shaped FLCD, saturation voltage control within 7V is not easy. Very strict materials quality control and process control, in particular UV polymerization process control is required to keep saturation voltage less than 7V. For large screen panel manufacturing, this quality and process control are very difficult in terms of keeping uniformity in large screen area. In order to keep wide enough process control window, lowering saturation voltage of liquid crystal is necessary. Moreover, current most popular and most economical liquid crystal drive array, which is an amorphous silicon TFT, does not have good enough electron mobility to supply good enough electron charges to liquid crystals having spontaneous polarization such as the liquid crystal for SSFLCDs, V-shaped FLCD and anti-ferroelectric liquid crystal displays.

In this purpose, mixing photo polymerization material should be eliminated. Without increasing additional new process such as UV polymerization process, maximizing current available stable manufacturing process is very important to keep cost competitive performance. Moreover, elimination of any spontaneous polarization from Smectic liquid crystal materials which is described in US patent application “US-2004/0196428 A1” is the most critical in terms of practical driving by conventional TFT arrays.

### SUMMARY OF THE INVENTION

An object of the present invention is to provide a liquid crystal display device which is capable of solving the above-mentioned problem encountered in the prior art.

Another object of the present invention is to provide a liquid crystal display device capable of providing a display performance which is better than the liquid display device in the prior art.

As a result of earnest study, the present inventor has found that, it is extremely effective to constitute a liquid crystal display device by using a specific liquid crystal material in a specific state wherein the molecular long axis or n-director of the Smectic phase liquid crystal material has a tilt angle to its layer normal as a bulk material, and the molecular long axis of the Smectic phase liquid crystal material aligns parallel to the pre-setting alignment direction.

The liquid crystal device according to the present invention is based on the above discovery. More specifically, the present invention relates to a liquid crystal device comprising: at least a pair of substrates; and
a Smectic phase liquid crystal material disposed between the pair of substrates,
wherein the molecular long axis or n-director of the Smectic phase liquid crystal material has a tilt angle to its layer normal as a bulk material, and the molecular long axis of the Smectic phase liquid crystal material aligns parallel to the pre-setting alignment direction, resulting in its long axis layer normal (i.e., thereby making its molecular long axis normal to its layer).

The present invention also provides a liquid crystal device comprising: at least a pair of substrates; and
a Smectic phase liquid crystal material disposed between the pair of substrates,
wherein the molecular long axis or n-director of the Smectic phase liquid crystal material has a tilt angle to its layer normal as a bulk material, and
the liquid crystal device shows extinction angle along with the initial pre-setting alignment direction.

The present invention further provides a liquid crystal device comprising: at least a pair of substrates; and
a Smectic phase liquid crystal material disposed between the pair of substrates, the Smectic phase liquid crystal material aligning its molecular long axis having a tilt angle to its layer normal as a bulk material,
wherein the molecular long axis of the Smectic phase liquid crystal material is forced to align to parallel to the pre-setting alignment direction thereby making its molecular long axis normal to its layer.

According to the present inventor's knowledge and investigation, it is presumed that the above-mentioned phenomenon that the molecular long axis of the Smectic phase liquid crystal material to align to parallel to the pre-setting alignment direction, thereby making its molecular long axis normal to its layer, is attributable to the provision of a strong enough azimuthal anchoring energy, as described hereinafter. Such a strong enough azimuthal anchoring energy may preferably be provided, e.g., by a certain alignment method as described hereinafter.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 schematically shows current RGB sub-pixel structure in TFT-LCDs.

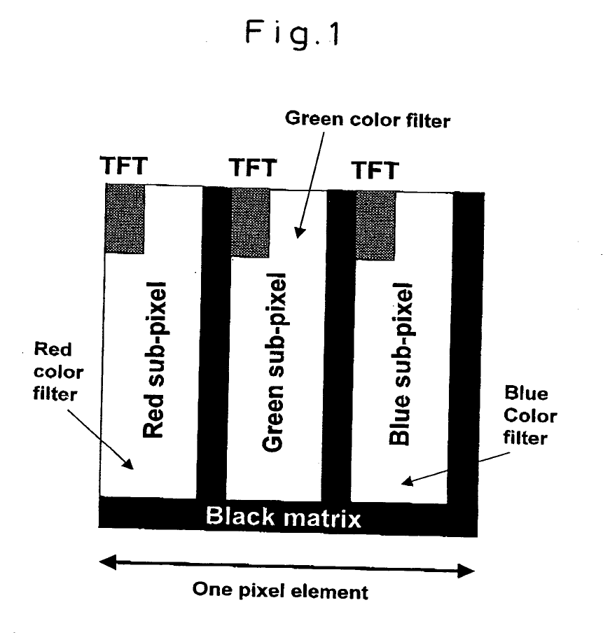

FIG. 2 schematically shows image velocity depending on screen diagonal size.

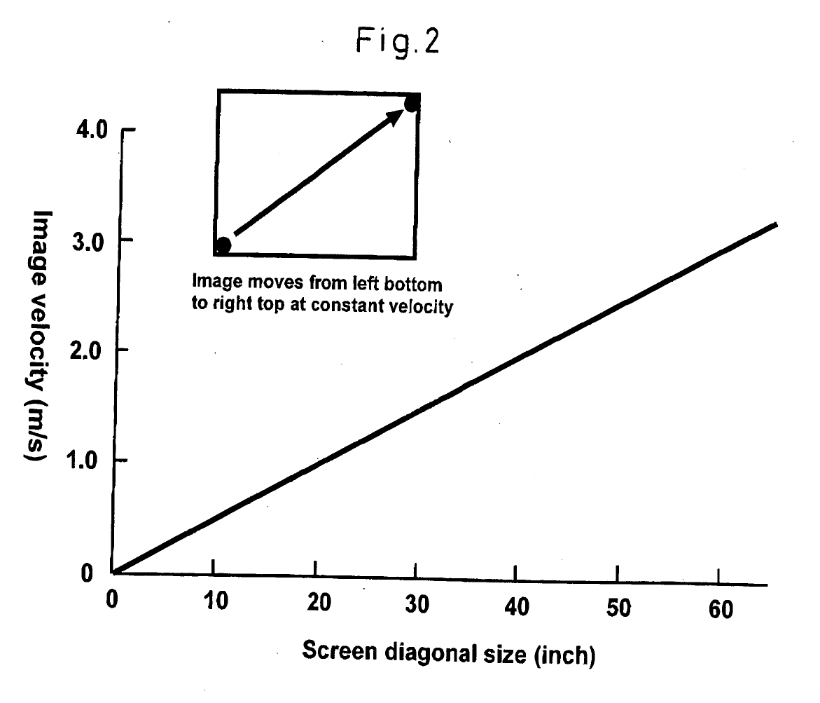

FIG. 3 schematically shows a pixel structure of field sequential color PSS-LCD.

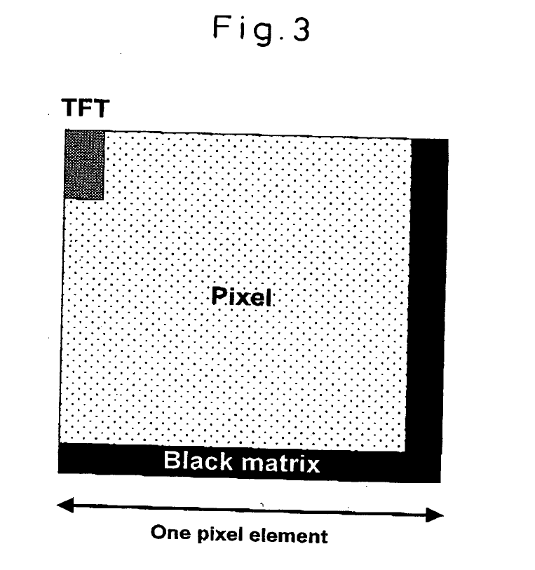

FIG. 4 schematically shows a slow response and a fast response, in field sequential color displays, respectively in a nematic-type display (a) and a PSS-type display (b).

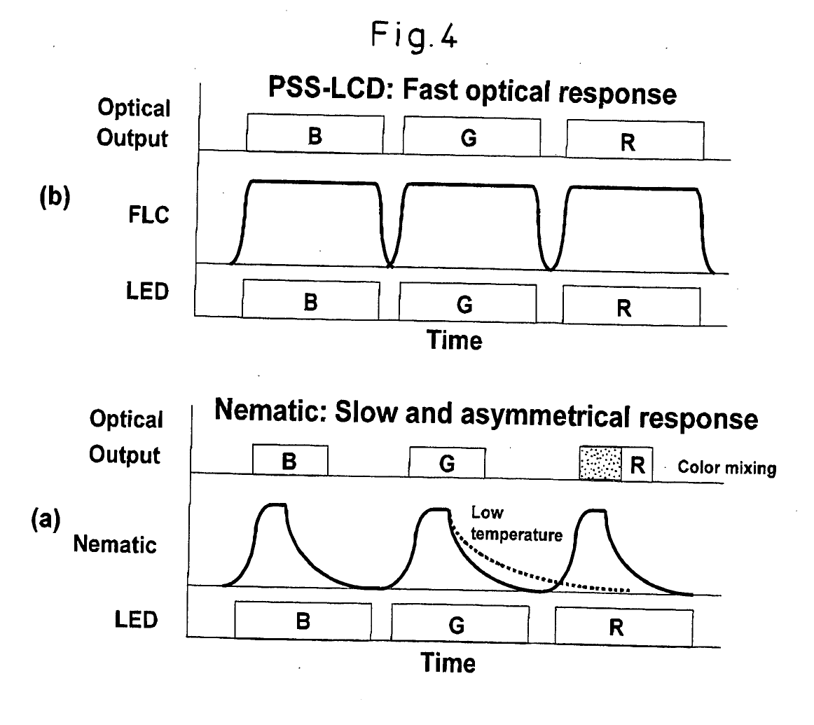

FIG. 5 schematically shows an example of initial molecular configuration and configuration under applied voltage of PSS-LCD.

FIG. 6 schematically shows an example of coordination of PSS-LC molecular setting.

FIG. 7 schematically shows an example of molecular tilt angle of smectic liquid crystal to smectic layer.

FIG. 8 schematically shows an example of dielectric behavior of SSFLCD and PSS-LCD.

FIG. 9 schematically shows examples of optical response of PSS-LCD.

FIG. 10 schematically shows an example of buffing angle of laminated panel.

FIG. 11 schematically shows an example of analog gray scale response of PSS-LCD.

FIG. 12 schematically shows an example of analog gray scale response of oblique evaporation alignment layer panel.

FIG. 13 schematically shows another example of analog gray scale response of oblique evaporation alignment layer panel.

FIG. 14 schematically shows an example of the design for the direction of the pre-set liquid crystal molecular alignment to be used in the present invention.

FIG. 15 schematically shows an example of the “dark” state at an isotropic phase.

FIG. 16 schematically shows another example of the “dark” state wherein the pre-set liquid crystal molecular alignment direction is parallel to the polarizer direction.

FIG. 17 schematically shows an example of the “light leakage” state wherein the liquid crystal panel is rotated, and the incident linearly polarized light changes its polarization.

FIG. 18 schematically shows an example of the liquid crystal molecular configuration of Smectic A phase having a layer structure

FIG. 19 schematically shows an example of the “light leakage” state of the smectic A phase, when the panel is rotated.

FIG. 20 schematically shows an example of the conventional smectic liquid crystals showing smectic C phase or chiral smectic C phase, depending on its achirality or chirality.

FIG. 21 schematically shows an example of the light transmittance situation of the PSS phase, which is the same as that of smectic A phase in general.

FIG. 22 schematically shows an example of the state wherein the tilt angle gradually increases with decrease of ambient temperature.

FIG. 23 schematically shows an example of the difference in n-director direction between conventional smectic C phase and the PSS-LC phase, in terms of temperature dependence of the light intensity by rotation of the liquid crystal panel under the crossed Nicole.

FIG. 24 schematically shows another example of the difference in n-director direction between conventional smectic C phase and the PSS-LC phase, in terms of temperature dependence of the light intensity by rotation of the liquid crystal panel under the crossed Nicole.

FIG. 25 schematically shows an example of the V-T (voltage to transmittance) curve of the PSS-LCD wherein the dependence of applied electric field strength of the PSS-LCD presents an analog response.

FIG. 26 schematically shows an example of the V-T curve of the conventional smectic C, or chiral smectic C phase wherein the V-T curve shows hysteresis.

### DETAILED DESCRIPTION OF PREFERRED EMBODIMENTS

Hereinbelow, the present invention will be described in detail with reference to the accompanying drawings, as desired. In the following description, “%” and “part(s)” representing a quantitative proportion or ratio are those based on mass, unless otherwise noted specifically.

(Liquid Crystal Device)

The liquid crystal device according to the present invention comprises, at least a pair of substrates; and a Smectic phase liquid crystal material disposed between the pair of substrates.

### First Embodiment

In a first preferred embodiment of the present invention, the liquid crystal device may preferably comprise, at least a pair of substrates; and a Smectic phase liquid crystal material disposed between the pair of substrates, wherein the molecular long axis or n-director of the Smectic phase liquid crystal material has a tilt angle to its layer normal as a bulk material, and the molecular long axis of the Smectic phase liquid crystal material aligns parallel to the pre-setting alignment direction, resulting in its long axis layer normal.

(Molecular Tilt from Layer Normal)

Using a polarized microscope whose analyzer and polarizer are set as cross Nicole, the liquid crystal molecular direction (n-director) is measurable. If the n-director is aligned as the layer normal, under the cross Nicole setting, the light transmittance through from the liquid crystal panel is the minimum or showing the extinction angle, when the pre-setting molecular alignment direction fits with the absorption angle of the analyzer. If the n-director is not aligned as layer normal, which has a tilt angle from the layer normal, under the cross Nicole setting, the light transmittance through the liquid crystal panel is not the minimum or not showing the extinction angle.

### Second Embodiment

In a second preferred embodiment of the present invention, the liquid crystal device may preferably comprise, at least a pair of substrates; and a Smectic phase liquid crystal material disposed between the pair of substrates, wherein the molecular long axis or n- director of the Smectic phase liquid crystal material has a tilt angle to its layer normal as a bulk material, and the liquid crystal device shows extinction angle along with the initial pre-setting alignment direction.

(Confirmation of Extinction Angle)

The above-mentioned extinction angle of the liquid crystal device may be confirmed by the following method.

Under a polarized microscope whose analyzer and polarizer are set as cross Nicole, the direction of the liquid crystal molecule's n-director is easily detected as following. At the theta-stage of the polarized microscope, the liquid crystal panel is rotated. The light through the panel is function of the rotational angle. If the light throughput shows the minimum, the angle given the minimum light is the extinction angle. If the light shows not the minimum, the angle given the non-minimum light throughput is not the extinction angle.

### Third Embodiment

In a third preferred embodiment of the present invention, the liquid crystal device may preferably comprise, at least a pair of substrates; and a Smectic phase liquid crystal material disposed between the pair of substrates, the Smectic phase liquid crystal material aligning its molecular long axis having a tilt angle to its layer normal as a bulk material, wherein the surface of the substrates has a strong enough azimuthal anchoring energy to cause the molecular long axis of the Smectic phase liquid crystal material to align to parallel to the pre-setting alignment direction making its molecular long axis normal to its layer.

(Confirmation of Strong Enough Azimuthal Anchoring Energy)

In the present invention, the above-mentioned strong enough azimuthal anchoring energy may be confirmed by confirming that the molecular long axis of the Smectic phase liquid crystal material aligns to parallel to the pre-setting alignment direction making its molecular long axis normal to its layer. This confirmation may be effected by the following method.

In general, azimuthal anchoring energy is measurable by so called the crystal rotation method. This method is described in such as “An improved Azimuthal Anchoring Energy Measurement Method Using Liquid Crystals with Different Chiralities”: Y. Saitoh and A. Lien, Journal of Japanese Applied Physics Vol. 39, pp. 1793 (2000). The measurement system is commercially available from several equipment companies. In here, particularly the strong enough azimuthal anchoring energy is very clear to be confirmed as following. The meaning of “strong enough azimuthal anchoring energy” is the most necessary to obtain the liquid crystal molecule's n-director aligned to along with pre-set alignment direction using the liquid crystal molecule whose n-director usually aligns with a certain angle of tilt from layer normal. Therefore, if the prepared surface successfully aligns the liquid crystal's n-director along with the pre-set alignment direction, it means “strong enough” anchoring energy.

(Liquid Crystal Material)

In the present invention, a Smectic phase liquid crystal material is used. Herein, “Smectic phase liquid crystal material” refers to a liquid crystal material capable of showing a Smectic phase. Accordingly, it is possible to use a liquid crystal material without particular limitation, as long as it can show a Smectic phase.

(Preferred Liquid Crystal Material)

In the present invention, it is preferred to use a liquid crystal material having the following capacitance property.

(Capacitance Property)

Although the PSS-LCD uses smectic liquid crystal materials, due to its expected origin of the induced polarization created from quadra-pole momentum, pixel capacitance at each LCD is small enough compared to conventional LCDs. This small capacitance at each pixel will not request any particular change of TFT design. The major design issue at TFT is its required electron mobility and its capacitance with keeping high aperture ratio. Therefore, if the new LCD drive mode requires more capacitance, TFT is necessary to have a major design change, which is not easy both in terms of technically and economically. One of the most important benefits of the PSS-LCD is its smaller capacitance as a bulk liquid crystal capacitance. Therefore, if the PSS-LC materials are used as a transmittance type of LCD, its pixel capacitance is almost half to one third compared to that of conventional nematic base LCD. It the PSS-LCD is used as reflective LCD such as LCoS display, its pixel capacitance is almost same with that for transmittance nematic base LCD, and almost half to one third compared that of reflective conventional nematic base LCD.

<Method of Measuring the Capacitance Property>

The pixel capacitance of the LCD is commonly measured by the standard method described in following.

Liquid crystal device handbook: Nikkan Kogyo in Japanese Chapter 2, Section 2.2: pp. 70, Measuring method of liquid crystal properties

A liquid crystal panel to be examined is inserted between a polarizer and an analyzer which are arranged in a cross-Nicole relationship, and the angle providing the minimum light quantity of the transmitted light is determined while the liquid crystal panel is being rotated. The thus determined angle is the angle of the extinction position.

(Liquid Crystal Material having Preferred Property)

In the present invention, it is required to use a liquid crystal material belonging to the least symmetrical group. The requirement for the PSS-LCD performance from the view point of the liquid crystal materials is enhancement of quadra-pole momentum in the liquid crystal device. Therefore, the used liquid crystal molecule must have the least symmetrical molecular structure. The exact molecular structure is dependent on the required performance as the final device. If the final device is for a mobile display application, rather low viscosity is more important than that for larger panel display application, resulting in smaller molecular weight molecules are preferred. However, the lower viscosity is the total property as the mixture. Some times, the mixture's viscosity is decided not by each molecular component, but by inter-molecular interaction. Even the optical performance requirement such as birefringence is also very dependent on application. Therefore, the most and solely requirement in the liquid crystal material here is its least symmetrical or the most asymmetrical molecular structure in the Smectic liquid crystal molecules.

(Specific Examples of Preferred Liquid Crystal Material)

In the present invention, it is preferred to use a liquid crystal material selected form the following liquid crystal materials. Of course, these crystal materials may be used as a combination or mixture of two or more kinds thereof, as desired. The Smectic liquid crystal material to be used in the present invention may be selected from the group consisting of: Smectic C phase materials, Smectic I phase materials, Smectic H phase materials, Chiral Smectic C phase materials, Chiral Smectic I phase material, Chiral Smectic H phase materials.

Specific examples of the Smectic liquid crystal material to be used in the present invention may include the following compounds or materials.

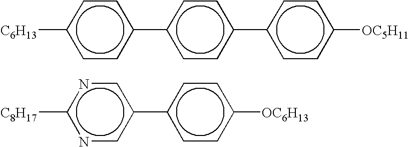

(Pre-Tilt Angle)

The surface of the substrates constituting the liquid crystal device according to the present invention may preferably have a pre-tilt angle to the filled liquid crystal material of no larger than 5 degrees, more preferably no larger than 3 degrees, further preferably no larger than 2 degrees. The pre-tilt angle to the filled liquid crystal material may be determined by the following method.

In general, the measurement method of pre-tilt at LCD device is used so called the crystal rotation method, which is popular and the measuring system is commercially available. However, here the required pre-tilt is not for Nematic liquid crystal materials, but for Smectic liquid crystal materials who has a layer structure. Therefore, the scientific definition of the pre-tilt angle is different from that for non-layer liquid crystal materials.

The requirement of the pre-tilt for the present invention is to stabilize azimuthal anchoring energy. The most important requirement for the pre-tilt is actually not for its angle, but stabilization of the azimuthal anchoring energy. As long as the pre-tilt angle does not have conflict with azimuthal anchoring energy, higher pre-tilt may be acceptable. So far, experimentally, current available alignment layers suggest lower pre-tilt angle to stabilize preferred molecular alignment. However, there is no particular scientific theory to deny higher pre-tilt angle requirement. The most important requirement to the pre-tilt is to provide stable enough PSS-LCD molecular alignment.

Most of commercially available polymer base alignment materials are sold with data of pre-tilt angle. If the pre-tilt angle is unknown, the value is measurable using the crystal rotation method as the representative pre-tilt for a specific cell condition.

(Provision of Anchoring Energy)

The method of providing the anchoring energy is not particularly limited, as long as the method may provide a strong enough azimuthal anchoring energy to cause the molecular long axis of the Smectic phase liquid crystal material to align to parallel to the pre-setting alignment direction making its molecular long axis normal to its layer. Specific examples of the method may include: e.g., mechanical buffing of a polymer layer; a polymer layer whose top surface has been exposed by polarized UV light; oblique evaporation of a metal oxide material, etc. Of these methods of providing the anchoring energy, a reference: Liquid crystal device handbook: Nikkan Kogyo in Japanese, Chapter 2, Section 2.1, 2.1.4: pp. 40, and 2.1.5 pp. 47, may referred to, as desired.

In the case of oblique evaporation of a metal oxide material, the oblique evaporation angle may preferably be no less than 70 degrees, more preferably no less than 75, further preferably no less than 80 degrees.

<Method of Measuring Molecular Initial Alignment State for Liquid Crystal Molecules>

In general, the major axis of liquid crystal molecules is in fair agreement with the optical axis. Therefore, when a liquid crystal panel is placed in a cross Nicole arrangement wherein a polarizer is disposed perpendicular to an analyzer, the intensity of the transmitted light becomes the smallest when the optical axis of the liquid crystal is in fair agreement with the absorption axis of the analyzer. The direction of the initial alignment axis can be determined by a method wherein the liquid crystal panel is rotated in the cross Nicole arrangement while measuring the intensity of the transmitted light, whereby the angle providing the smallest intensity of the transmitted light can be determined.

<Method of Measuring Parallelism of Direction of Liquid Crystal Molecule Major Axis with Direction of Alignment Treatment>

The direction of rubbing is determined by a set angle, and the slow optical axis of a polymer alignment film outermost layer which has been provided by the rubbing is determined by the kind of the polymer alignment film, the process for producing the film, the rubbing strength, etc. Therefore, when the extinction position is provided in parallel with the direction of the slow optical axis, it is confirmed that the molecule major axis, i.e., the optical axis of the molecules, is in parallel with the direction of the slow optical axis.

(Substrate)

The substrate usable in the present invention is not particularly limited, as long as it can provide the above-mentioned specific “molecular initial alignment state”. In other words, in the present invention, a suitable substrate can appropriately be selected in view of the usage or application of LCD, the material and size thereof, etc. Specific examples thereof usable in the present invention are as follows

A glass substrate having thereon a patterned a transparent electrode (such as ITO)

An amorphous silicon TFT-array substrate

A low-temperature poly-silicon TFT array substrate.

A high-temperature poly-silicon TFT array substrate

A single-crystal silicon array substrate.

(Preferred Substrate Examples)

Among these, it is preferred to use following substrate, in a case where the present invention is applied to a large-scale liquid crystal display panel.

An Amorphous Silicon TFT Array Substrate

(Alignment Film)

The alignment film usable in the present invention is not particularly limited as long as it can provide the above-mentioned tilt angle, etc., according to the present invention. In other words, in the present invention, a suitable alignment film can appropriately be selected, in view of the physical property, electric or display performance, etc. For example, various alignment films as exemplified in publications may generally be used in the present invention. Specific preferred examples of such alignment films usable in the present invention are as follows.

Polymer alignment film: polyimides, polyamides, polyamide-imides

Inorganic alignment film: SiO2, SiO, Ta2O5, ZrO, Cr2O3, etc.

(Preferred Alignment Film Examples)

Among these, it is preferred to use the following alignment film, in a case where the present invention is applied to a projection-type liquid crystal display.

Inorganic Alignment Films

In the, present invention, as the above-mentioned substrates, liquid crystal materials, and alignment films, it is possible to use those materials, components or constituents corresponding to the respective items as described in “Liquid Crystal Device Handbook” (1989), published by The Nikkan Kogyo Shimbun, Ltd. (Tokyo, Japan), as desired.

(Other Constituents)

The other materials, constituents or components, such as transparent electrode, electrode pattern, micro-color filter, spacer, and polarizer, to be used for constituting the liquid crystal display according to the present invention, are not particularly limited, unless they are against the purpose of the present invention (i.e., as long as they can provide the above-mentioned specific molecular initial alignment state). In addition, the process for producing the liquid crystal display device which is usable in the present invention is not particularly limited, except the liquid crystal display device should be constituted so as to provide the above-mentioned specific molecular initial alignment state”. With respect to the details of various materials, constituents or components for constituting the liquid crystal display device, as desired, “Liquid Crystal Device Handbook” (1989), published by The Nikkan Kogyo Shimban, Ltd. (Tokyo, Japan) may be referred to.

(Means for Realizing Specific Initial Alignment)

The means or measure for realizing such an alignment state is not particularly limited, as long as it can realize the above-mentioned specific “molecular initial alignment state”. In other words, in the present invention, a suitable means or measure for realizing the specific initial alignment can appropriately be selected, in view of the physical property, electric or display performance, etc.

The following means may preferably be used, in a case where the present invention is applied to a large-sized TV panel, a small-size high-definition display panel, and a direct-view type display.

(Preferred Means for Providing Initial Alignment)

According to the present inventors' investigation and knowledge, the above-mentioned suitable initial alignment may easily be realized by using the following alignment film (in the case of baked film, the thickness thereof is shown by the thickness after the baking) and rubbing treatment. On the other hand, in ordinary ferroelectric liquid crystal displays, the thickness of the alignment film 3,000 A (angstrom) or less, and the strength of rubbing (i.e., contact length of rubbing) 0.3 mm or less.

Thickness of alignment film: preferably 4,000 A or more, more preferably 5,000 A or more (particularly, 6,000 A or more).

Strength of rubbing (i.e., contact length of rubbing): preferably 0.3 mm or more, more preferably 0.4 mm or more (particularly, 0.45 mm or more) The above-mentioned alignment film thickness and strength of rubbing may be measured, e.g., in a manner as described in Example 1 appearing hereinafter

(Comparison of the Present Invention and Background Art)

Herein, for the purpose of facilitating the understanding of the above-mentioned structure and constitution of the present invention, some features of the liquid crystal device according to the present invention will be described in comparison with those having different structures.

(Theoretical Background of the Invention)

The present invention is based on detail investigation and analysis of molecular alignment of the PSS-LCDs, which is thought to be significant advantages for small screen with high resolution LCDs and large screen direct view LCD TV applications as well as large magnified projection panels. Next, the technical background of the invention will be described.

(Polarization Shielded Smectic Liquid Crystal Displays)

The polarization shielded Smectic liquid crystal display (PSS-LCD) is described in the United States Patent application number US-2004/0196428 A1 that using the least symmetrical molecular structure's liquid crystal materials in order to enhance quadra-pole momentum. This patent application discusses the basic mechanism of the PSS-LCD. Also this patent describes a practical method to manufacture the PSS-LCDs.

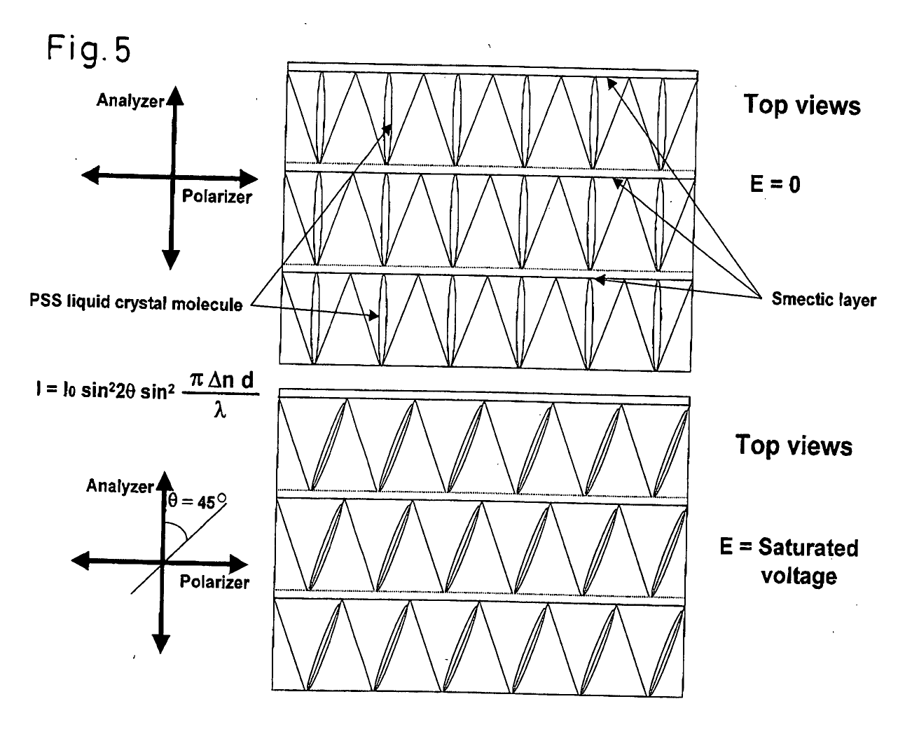

As described in above patent applications, one of the most unique points of the PSS-LCD is to have a specific liquid crystal molecular alignment as the initial alignment state. Using a certain kind of Smectic liquid crystal materials whose natural molecular n-director alignment has a specific tilt from the Smectic layer in conjunction with the strong azimuthal anchoring energy of the surface, this molecular n-director is forced to align layer normal. In another word, the least symmetrical molecule whose n-director has a certain tilt angle from the layer normal is aligned its n-director with layer normal by a specific artificial alignment force as illustrated in FIG. 5.

This initial alignment creates unique display performance at the PSS-LCD. This molecular alignment is similar with Smectic A phase whose n-director is normal to the layer, however, this specific molecular alignment is realized only when the liquid crystal molecules are under the strong azimuthal anchoring energy surface with weaker polar anchoring surface condition. Therefore, these molecules are called as the Polarization Shielded Smectic or PSS phase. This patent application provides the fundamental method to give the most necessary condition to realize high performance PSS-LCDs. In order to realize this artificial n-director alignment at the PSS-LCD, strong azimuthal molecular alignment as well as weaker polar anchoring is the most necessary as described in the patent application.

The conventional nematic base LCDs use steric interaction based on Van der Waals force for their initial molecular alignment. The steric interaction gives a good enough initial molecular anchoring energy for the most of nematic liquid crystal molecules whose molecular anchoring is ordering n-director without necessity of n-director change artificially. Because of alignment nature of nematic liquid crystal molecules, their n-directors are always aligned in one same direction under the certain order parameter.

Unlike nematic liquid crystal molecules, Smectic liquid crystal molecules form a layer structure. This layer structure is not a real structure, but a virtual structure. Due to higher order parameter of Smectic liquid crystal than that for nematic liquid crystal, Smectic liquid crystal molecules have higher order molecular alignment forming their mass center alignment. Compared to natural molecular alignment of Smectic liquid crystals, nematic liquid crystals never align themselves keeping their mass center in a certain order such as that of Smectic liquid crystals.

The present invention is based on the basic research of the azimuthal anchoring energy and polar anchoring energy in terms of initial molecular n-director in Smectic phase of the least symmetrical Smectic liquid crystal molecules on a certain alignment surface. As one of the well known phenomena, the steric interaction based on Van der Waals interaction is much weaker than that is provided by Coulomb-Coulomb interaction. In the present invention, based on detailed investigations on the surface interaction (specifically, on the surface interaction between the least symmetrical Smectic liquid crystal molecules and a high polarity surface of the alignment layer), the enhancement of the Coulomb-Coulomb interaction between the Smectic liquid crystal molecules and a certain alignment surface, has been accomplished.

(Theoretical Analysis of the Surface Anchoring in the PSS-LCD)

The present invention should not restricted by any theory. The following description of a certain theory is based on the present inventor's knowledge and various investigations (inclusive of studies and experiments), and such a theory is described here only for the purpose of better understanding of a possible mechanism of the present invention.

In order to clarify necessary condition for the initial PSS-LC configuration, a free energy of the PSS-LC cell is considered based on the following expression. Three primary free energies are expressed as following:
(a) Elastic Energy Density: fₑₗₐₛ

$${f}_{elas} = \frac{B}{2} {( \frac{\partial ϕ}{\partial x} )}^{2} - {D}_{1} ( \frac{\partial ϕ}{\partial x} ) sin ϕ \qquad Equation ( 1 )$$

where B and D1 are Smectic layer and viscous elastic constant, respectively

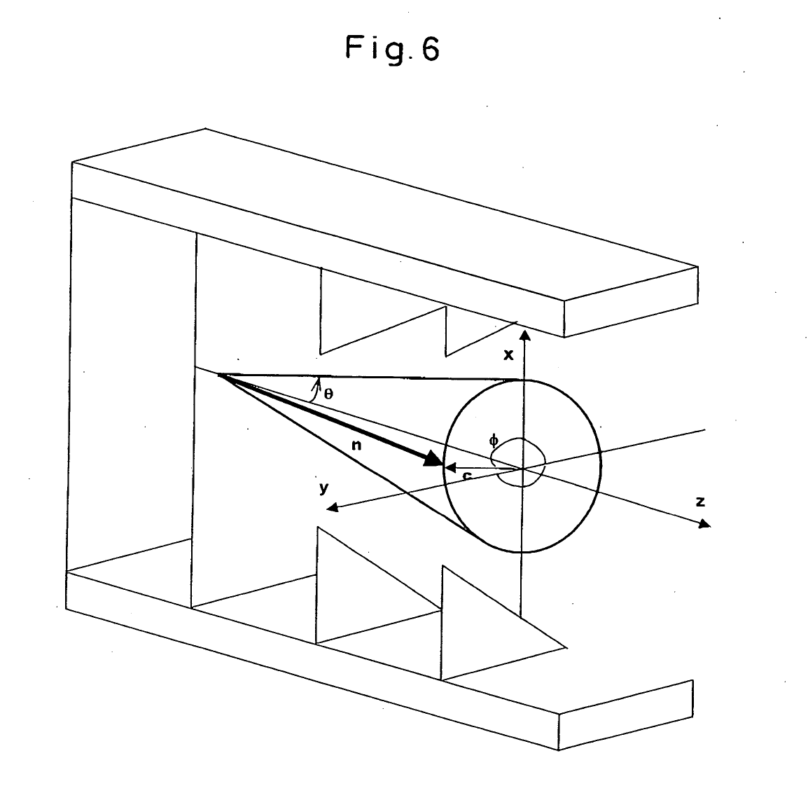

The coordinate system is set as shown in FIG. 6.

where φis the azimuth presented in FIG. 6, x is set as cell thickness direction.
(b) Elastic Interaction Energy: f_{elec}

$${f}_{elec} = - \frac{1}{2} {Δ ɛ {( \frac{\partial ψ}{\partial x} )}^{2}}^{{f}_{elec}} - \frac{1}{2} {{ɛ}_{⊥ 1} ( \frac{\partial ψ}{\partial x} )}^{2} - \frac{1}{2} {{ɛ}_{⊥ 2} ( \frac{\partial ψ}{\partial x} )}^{2} \qquad Equation ( 2 )$$

An electric field is given by the electrostatic potential φ: i.e.;

The dielectric anisotropy terms represented by

$$- \frac{1}{2} {{ɛ}_{⊥ 1} ( \frac{\partial ψ}{\partial x} )}^{2} and - \frac{1}{2} {{ɛ}_{⊥ 2} ( \frac{\partial ψ}{\partial x} )}^{2} Ex = - \frac{\partial ψ}{\partial x}$$

for expressing contribution from quadra pole momentum.

(c) Surface Interaction Energy Density: F_{surf}

According to Dahl and Lagerwall of their paper in Molecular Crystals and Liquid Crystals, Vol. 114, page 151 published in 1984, the surface interaction energy density is expressed as;
f_{surf}=θ(−γₚ⁰ cos φ⁰+γₚ¹ cos φ¹)+{γₜ⁰(θ sin φ⁰−αₜ⁰)²+γₜ¹(θ sin φ¹±αₜ¹)²}+{γ_{d}⁰(θ cos φ⁰−α_{d}⁰)²+γ_{d}¹(θ cos φ¹+α_{d}¹)²} Equation (3)

Where θis molecular tilt angle presented in FIG. 6, γp, γt, γd: are surface interaction coefficients, at is pre-tilt angle, and ad is the preferred direction angle from z-direction set in FIG. 6.

Regarding the surface interaction energy density, the required condition in terms of the initial molecular alignment condition of the PSS-LCD is θ=0 and f=3π/2 in FIG. 6. Taking account into these conditions, the equation (3) is now;
f_{surf}=γₜ⁰(αₜ⁰)²+γₜ¹(αₜ¹)²+γ_{d}⁰(α_{d}⁰)²+γ_{d}¹(α_{d}¹)² Equation (4)

Also, the preferred pre-tilt angle of the PSS-LCD is zero, then the equation (4) goes to;
f_{surf}=α_{d}²(γ_{d}⁰+γ_{d}¹) (Equation (5)

Using the equations (1), (2), and (5), the total free energy per unit area F is;

$$\begin{matrix}F = {\int }_{0}^{d} ( {f}_{elas} + {f}_{elect} ) ⅆ x + {f}_{surf} \\ = {\int }_{0}^{d} \{ ( \frac{B}{2} {( \frac{\partial ϕ}{\partial x} )}^{2} - D \frac{\partial ϕ}{\partial x} sin ϕ ) + ( - \frac{1}{2} Δ {ɛ ( \frac{\partial ψ}{\partial x} )}^{2} - \\ \frac{1}{2} {{ɛ}_{⊥ 1} ( \frac{\partial ψ}{\partial x} )}^{2} - \frac{1}{2} {{ɛ}_{⊥ 2} ( \frac{\partial ψ}{\partial x} )}^{2} \} ⅆ x + {α}_{d}^{2} ( {γ}_{d}^{0} + {γ}_{d}^{1} )\end{matrix} \qquad Equation ( 6 )$$

here, the symmetrical surface anchoring: γd0=γd1, and φ→3p/2 are introduced in the equation (6);

$$\begin{matrix}F = {\int }_{0}^{d} \{ ( \frac{B}{2} {( \frac{\partial ϕ}{\partial x} )}^{2} - D \frac{\partial ϕ}{\partial x} ) - \frac{1}{2} ( Δ ɛ + {ɛ}_{⊥ 1} + {ɛ}_{⊥ 2} ) \\ {( \frac{\partial ψ}{\partial x} )}^{2} \} ⅆ x + 2 {γ}_{d} {α}_{d}^{2}\end{matrix} \qquad Equation ( 7 )$$

As the initial state, E=0 is introduced to equation (7),

$${( \frac{\partial ψ}{\partial x} )}^{2} = 0 \\ F {\int }_{0}^{d} \{ \frac{B}{2} {( \frac{\partial ϕ}{\partial x} )}^{2} - D \frac{\partial ϕ}{\partial x} \} ⅆ x + 2 {γ}_{d} {α}_{d}^{2} \qquad Equation ( 8 )$$

here, the preferred direction angle d_{d} is set to z-direction, and viscous elastic constant D can be expressed as;

$$\begin{matrix}D = \frac{η}{2} {( \frac{\partial ϕ}{\partial x} )}^{2} \\ To minimize F ; & Equation ( 9 ) \\ \frac{B}{2} {( \frac{\partial ϕ}{\partial x} )}^{2} = D \frac{\partial ϕ}{\partial x} & Equation ( 10 ) \\ & Equation ( 11 )\end{matrix}$$

Therefore, it is clear that the PSS-LC molecule should be parallel to z-direction shown in FIG. 6. Also the equation (10) leads to the condition that the PSS-LC molecules need to stack from the bottom to top surfaces in uniform to meet with the specific Smectic layer elastic constant and liquid crystal molecular viscosity in the same layer.

α_{d}=A0s described above, the intrinsic concept of the present invention is based on the enhancement of Smectic liquid crystal molecular director, which has a tilt angle from Smectic layer normal, along with set alignment direction such as buffing direction. Using a certain category of Smectic liquid crystal molecules whose molecular directors have a tilt angle to the Smectic layer normal as a bulk shape, the enhancement of molecular director alignment forces the Smectic liquid crystal molecular directors along with pre-set alignment direction. This enhancement enables the Smectic liquid crystal molecular directors to align perpendicular to the Smectic layer as illustrated in FIG. 5.

The unique electro-optical performance of the PSS-LCD can be created by this specific molecular alignment of the Smectic liquid crystal molecules. One of these unique characteristic properties of the PSS-LCDs may be its relationship between a panel gap and drive voltage.

In the case of most of known LCDs, they need higher drive voltage by increasing their panel gap. Because of increase of panel gap, the required applied voltage needs to be increased to keep the strength of the electric field.

In the PSS-LCD according to the present invention, however, sometimes needs less voltage, when the panel gap increases. Due to requirement of strong azimuthal anchoring energy at the PSS-LCD panel, increase in panel gap provides weakening of anchoring in the liquid crystal molecules in the panel, resulting in lower voltage for the driving. This fact is also one of the proofs of the above described interpretation of the PSS-LCDs.

(Practical Method to Enhance Coulomb-Coulomb Interaction)

Because of existence of a layer structure of the Smectic liquid crystals, a specific balance between the layer structure and the alignment interface is always of great concern in terms of a clean molecular alignment. In particular the case of the PSS-LCD which requires strong azimuthal anchoring energy, how the strong anchoring energy is given to the liquid crystal molecules without disturbing their native layer structure is the most important.

As discussed theoretically in previous section, strong azimuthal anchoring is the most necessary to realize the PSS-LCD configuration. The inventor had experimental efforts to find out the practical method to give rise the strong anchoring energy without disturbing the formation of the native liquid crystal layer structure. In the course of the experimental efforts, it has been found that emphasizing some specific liquid crystal molecules out of the total PSS-LC mixture is one of the effective methods to provide strong enough anchoring energy in accordance with forming the layer structure. Due to the strong self-formation power of the layer structure in Smectic liquid crystals, it was not easy to give rise strong enough anchoring energy. If the surface anchoring is too strong, the formed layer structure of the Smectic liquid crystals is distorted, or in the worst case, destroyed. Prioritizing the clean layer structure always results in failure of the PSS-LC molecular alignment that could not form the Smectic liquid crystal molecular n-director alignment is normal to the layer. The most important to obtain clean molecular alignment in the PSS-LCD is to provide strong azimuthal anchoring energy with weak adhesive anchoring energy, which is the polar anchoring energy, to the liquid crystal molecules.

Therefore, the PSS-LCD accepts inorganic alignment materials as long as they provide strong enough azimuthal anchoring with weak polar anchoring energy. This provides significant advantage to the PSS-LCD for projector panel applications.

Due to strong light flux, most of current polymer base alignment layers have a problem in their life time. However, due to requirement of rather strong polar anchoring for most of conventional nematic base LCDs, inorganic alignment layer has been not easy in their application to projector panels. On the contrary, the PSS-LCDs requires no particular polar anchoring energy, rather than requiring polar anchoring energy, the PSS-LCDs require weak or even no polar anchoring energy, but strong azimuthal anchoring energy. Therefore, most of inorganic base alignment layers provide very effective molecular alignment to the PSS-LCDs. In other words, in the present invention, it is possible to use any inorganic base alignment layer without particular limitation, as long as it provides a strong azimuthal anchoring energy.

(Some Features of PSS-LCD According to the Present Invention)

(Capacitance at Each Display Pixel)

One of the most distinguished features of the PSS-LCD is its smaller capacitance at each display pixel such as a pixel at amorphous silicon thin film transistor (hereinafter, referred to as “a-Si TFT”) pixel pad. In an a-Si TFT LCD, smaller capacitance of the pixel, which comes from the dielectric constant of the liquid crystal material, is one of the greatest concerns in terms of image performance. If the pixel capacitance is large, the transient voltage at the pixel changes very quickly, resulting in unfavorable image performance such as flicker, image retention. Some of the large capacitance of the pixel is absorbable by sophisticated design of a-Si circuit, however, very complicated pixel design has strong tendency to reduce a-Si TFT manufacturing yield. Therefore, smaller capacitance is one of the most important factors to provide higher image performance and lower manufacturing cost.

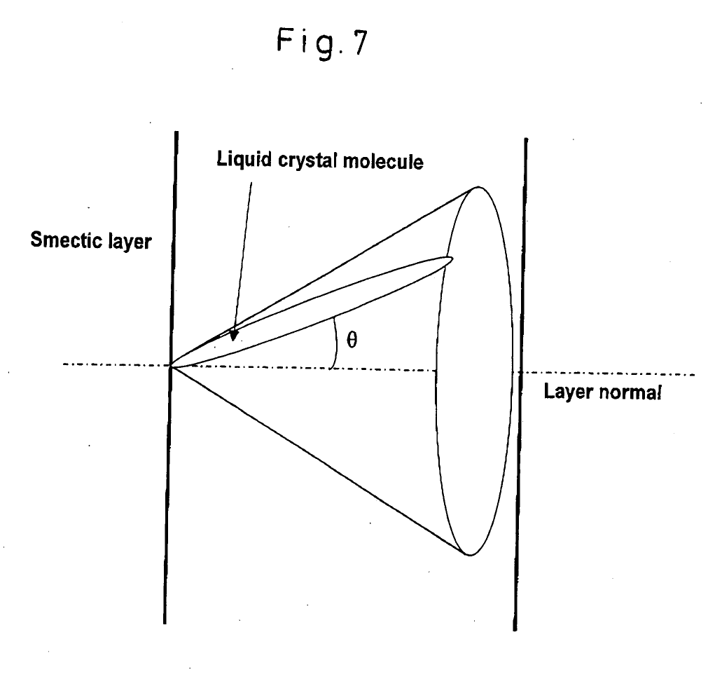

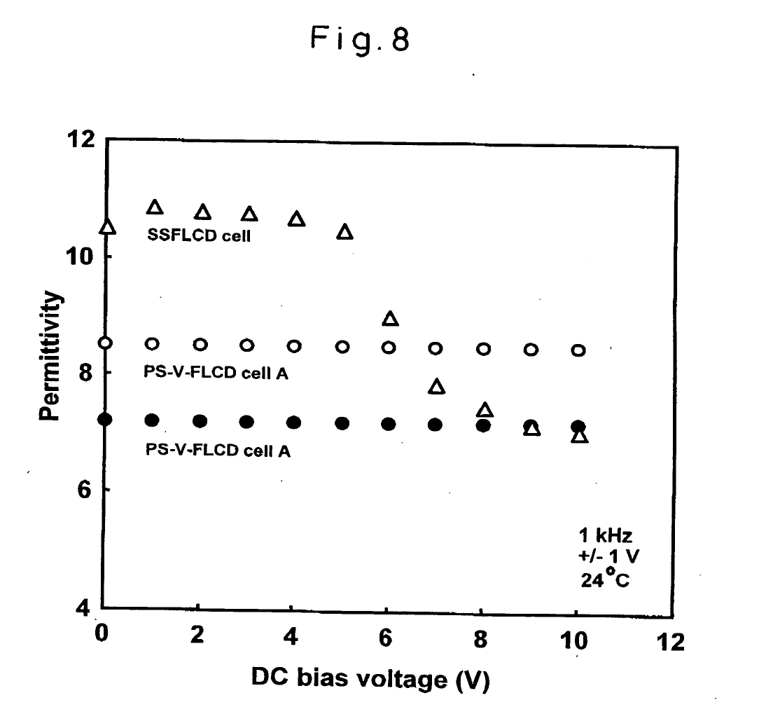

Nematic liquid crystal displays based on dipole momentum torque need to have large enough dipole momentum to reduce the drive voltage and obtaining faster optical response. Because the low enough drive voltage and faster optical response are the most necessary requirement for practical LCDs, nematic base LCDs have sacrificed complicated design of TFT array and manufacturing process efforts. On the contrary, the PSS-LCD has smaller capacitance than that for nematic base LCDs. In general, the pixel capacitance of the PSS-LCD is at least half of the nematic LCDs, some times it is quarter of the nematic LCDs. Thanks to quadra-pole momentum base torque and very short distance in liquid crystal molecular move as illustrated in FIG. 7, the PSS-LCD is drivable with smaller pixel capacitance with fast enough optical response. One of the actual examples of the capacitance is measured in FIG. 8.

As shown in FIG. 8, dielectric constant of the PSS-LCD is smaller than that for nematic base LCDs. Moreover, the dielectric constant of the PSS-LCD is much smaller-than that for conventional SSFLCDs. Due to spontaneous polarization of the SSFLCD, an effective dielectric constant of the SSFLCD is much larger than that for nematic LCDs, resulting in too much burden for a-Si TFT drive. Actually, conventional a-Si TFT is not able to drive SSFLCDs due to too large requirement of electron charges for spontaneous polarization switch of the SSFLCD. Therefore, the small capacitance of the PSS-LCD is one of the most distinguished features to differentiate its significance both from SSFLCDs and nematic base LCDs.

(Change in Capacitance Before and After Optical Switching)

The other distinguished feature of the PSS-LCDs from conventional SSFLCDs and nematic base LCDs is smaller change in capacitance before and after the optical switching of the liquid crystals. Similar to above discussion, smaller change at pixel pad at TFT array is of most important requirement for TFT-LCDs in terms of stable image performance without showing flicker and image retention.

A transient voltage drop at TFT, which is well known as “feed through voltage”, is inevitable at TFT-LCDs as long as the liquid crystal material has different capacitance before and after the optical switching. This feed through voltage is the root cause to create flicker and image retention. However, the different capacitance before and after the optical switching is very intrinsic nature of the liquid crystal, in particular for dipole momentum base and spontaneous polarization base liquid crystals.

In order to avoid flicker and image retention, conventional TFT-LCDs put some varieties of method to minimize the problems. However, the most intrinsic method is to use small or almost no change in capacitance materials. Despite many efforts to minimize this change in capacitance, the change in capacitance before and after the optical switching is very intrinsic nature of the conventional liquid crystal materials both in nematic base and ferroelectric liquid crystals as described above.

The PSS liquid crystal material which uses quadra-pole momentum does not need to have large capacitance change because of its very small dielectric constant and very short distance to move to create large enough birefringence for high contrast ratio at LCDs. The actual capacitance change before and after the optical switching of the PSS-LCDs is compared to that of conventional SSFLCD in FIG. 8.

In FIG. 8, in order to induce optical switching, DC bias voltage is applied to sample cells. The applied DC voltage is over the threshold voltage, optical switching is created. In FIG. 8, this threshold voltage for the PSS-LCD panels is around 0.5V, and that for the SSFLCD panel is around 6V. As shown in FIG. 8, the SSFLCD shows significant capacitance change. On the contrary, the PSS-LCD panels do not show any significant change in capacitance. This very small, or almost no change in capacitance before and after optical switching is the very distinguished characteristic properties of the PSS-LCDs. As long as the inventor has known so far, this small or almost no change in capacitance has not known in any LCDs except for the PSS-LCDs.

The measurement method of the capacitance in FIG. 8 is following.

(Measurement Method of Capacitance)

Using 35 mm square sized non-alkaline glass substrate, alignment layer is formed on the surface of the glass. The glass substrate has 15 mm diameter round shape ITO electrode at the center of the glass substrate. The formed alignment layer aligns PSS liquid crystal molecules in proper configuration. One of the typical alignment method is using specific poly-imide layer with mechanical buffing at the top surface of the poly-imide, which is well known and industrial standard process. The typical panel gap of the PSS-LC panel is 2 micron. For the measurement of FIG. 8, average diameter of 1.8 micron of silicon dioxide balls are used as spacer balls. After the perimeter area is sealed by epoxy glue, liquid crystal materials are injected into the panel and obtains the liquid crystal filled panel. For the measurement of the capacitance or dielectric constant of the filled cell, 1 kHz, ±1V of square waveform is applied to the sample cells as prove voltage. Bias DC voltage is also applied to the sample cell. This DC bias voltage induces optical switching of the sample cell, once the voltage is large enough to switch the n-director of the liquid crystal molecules.

(Desirable Embodiment of the Present Invention)

The core concept of the present invention is to emphasize initial molecular n-director normal to the Smectic liquid crystal layer. The role of this surface emphasis is to provide strong enough Coulomb-Coulomb interaction between the PSS liquid crystal molecules and the specific surface in terms of giving rise to azimuthal anchoring and keeping relatively weak polar anchoring to the PSS liquid crystal molecules.

As described above, some desirable embodiments of the present invention is followings:

(1) Use the specific Smectic liquid crystal materials whose molecular n-directors have some tilt angle from their Smectic layer normal illustrated in FIG. 7.

(2) Those Smectic liquid crystals belong to Smectic C, Smectic H, Smectic I phases and other least symmetrical molecular structure phase group. Chiral Smectic C, Chiral Smectic H, Chiral Smectic I phases also satisfy the necessary criteria for the PSS-LCD performance as described in US patent application US-2004/0196428 A1.

(3) Applying strong azimuthal anchoring as well as weaker polar anchoring energy, the natural n-director tilt from the Smectic layer normal is forced to be layer normal. As the result of this function, the PSS liquid crystal materials generally show following phase sequence:

Isotropic—(Nematic)—Smectic A—PSS phase—(Smectic X)—Crystal. Here, the blanket “( )” means not always necessary.

(4) One of the distinguished characteristic properties of the PSS-LCD is keeping same extinction angle between that in Smectic A phase and in the PSS phase. Extinction angle of the Smectic C phase is always different from that of Smectic A phase due to the molecular tilt angle from layer normal of the Smectic C phase. Therefore, the same extinction angle between Smectic A phase and the PSS phase is the unique property of the PSS phase.

(5) As the result of above function, the aligned PSS-LC cell shows a small anisotropy of dielectric constant such as less than 10, more preferably less than 5, most preferably less than 2. The anisotropy of dielectric constant is a function of measured frequency in the PSS-LCD. Due to the use of quadra-pole momentum unlike dipole-momentum for most of conventional LCDs, the anisotropy of dielectric constant is dependent on frequency of the prove voltage. Here the preferable value of the anisotropy of dielectric constant should be measured at 1 kHz of rectangular waveform. Unlike dipole-momentum coupling of the conventional LCDs, The PSS-LCD needs relatively small anisotropy of dielectric constant because of enhancement of quadra-pole momentum. This small anisotropy of dielectric constant is very helpful in drivability of TFTs. Thanks to smaller dielectric load for the TFT compared to that of conventional LCDs; the PSS-LCD has relatively small influence of Para-capacitance, which creates voltage shift for the TFT. Therefore, the PSS-LCD has wider drive window for conventional TFT arrays.

For example, one of the typical PSS-LC material shows anisotropy of dielectric constant of 1.5 using above measuring condition. This provides less than quarter of capacitance in the LCD panel compared to that of conventional TN-LCD panel. This means that the PSS-LCD realizes smaller feed through voltage in TFT-LCDs, resulting in stable and better image performance than that of conventional nematic base TFT-LCDs. FIG. 8 directly proves no involvement of spontaneous polarization and extremely small change in its dielectric constant before and after the optical switching of the PSS-LCD. From the result of FIG. 8, it is obvious that the PSS-LCD uses very small anisotropy of dielectric constant for its drive force. This is also one of the proofs of direct involvement of quadra-pole momentum in the PSS-LCD.

(6) The prepared PSS-LCD cell satisfying above conditions show specific direction of molecular tilt dependent on the direction of externally applied electric field. Due to the quadra-pole coupling, the PSS-LC molecule tells difference of the direction of applied electric field. This is one of the very different characteristic properties of the PSS-LCD. All of conventional nematic base LCDs using birefringence mode utilize dipole-momentum coupling, therefore, they do not tell the difference of the direction of applied electric field. Only the difference in potential of applied voltage drives those LCDs. The PSS-LCD molecules change their tilt direction by detecting the direction of applied voltage, although they do not have spontaneous polarization. This is also one of the supporting theories of quadra-pole momentum base drive of the PSS-LCD.

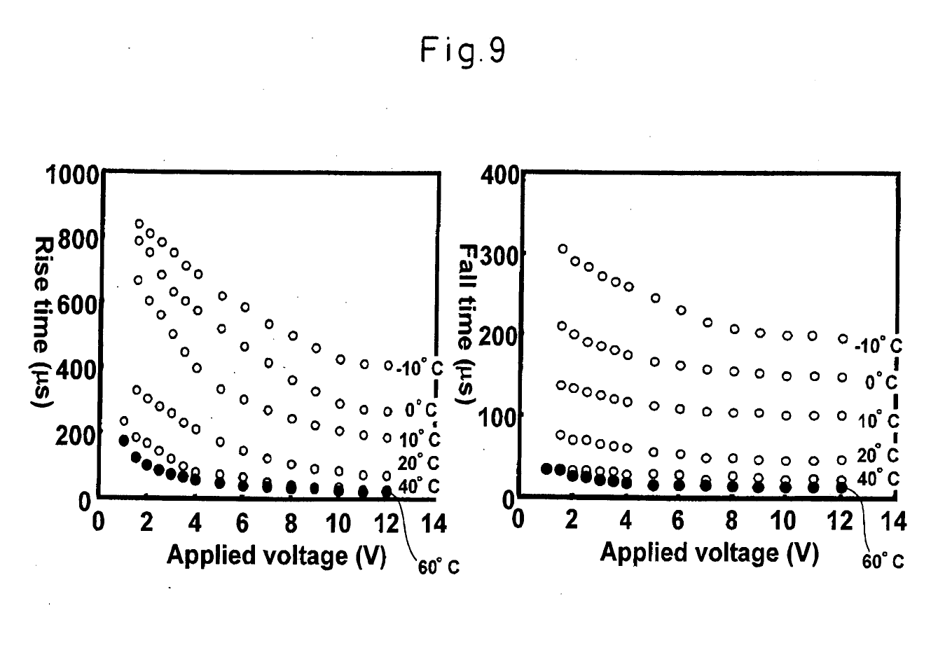

In spite of using very small anisotropy of dielectric constant based on quadra-pole momentum, the PSS-LCD shows extremely fast optical response such as sub-mille seconds both in rise and decay times. The major reason of the extremely fast optical response is its small distance of molecular tilt along the cone edge to create large enough birefringence as illustrated in FIG. 5. Unlike all of nematic base LCDs, the PSS-LCD requires very small distance in the molecular position change to create large enough birefringence. The very uniform molecular tilt along the cone edge shown in FIG. 5 also realizes extremely fast optical response such as shown in FIG. 9.

(Phase Sequence and Light Transmittance Situation)

The phase sequence and light transmittance situation at each phase are following.

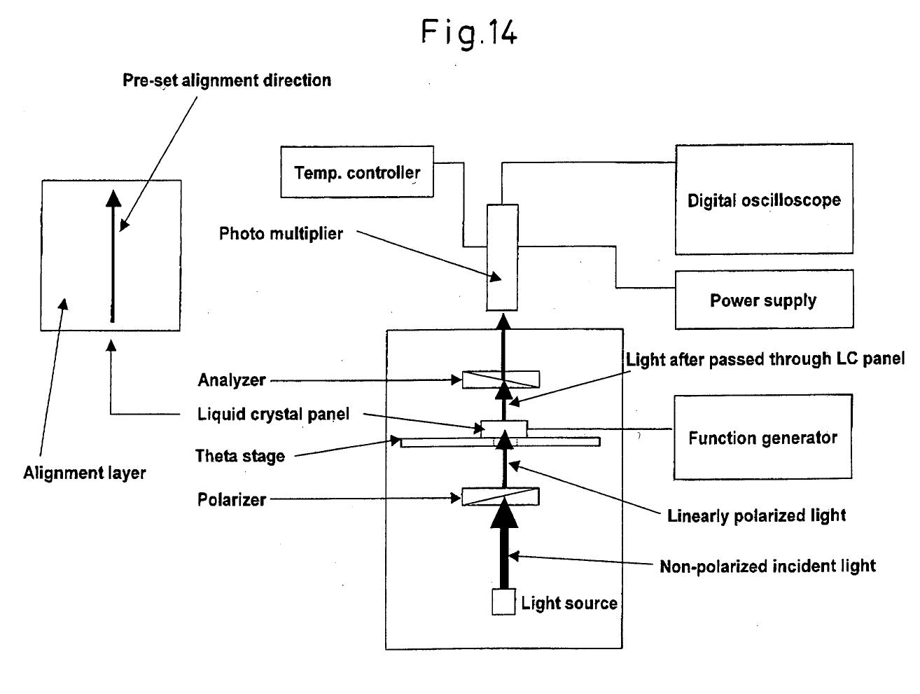

Under the crossed Nicole, a liquid crystal panel presents its specific light transmittance at each phase. In this situation, the direction of the pre-set liquid crystal molecular alignment is designed as illustrated in FIG. 14.

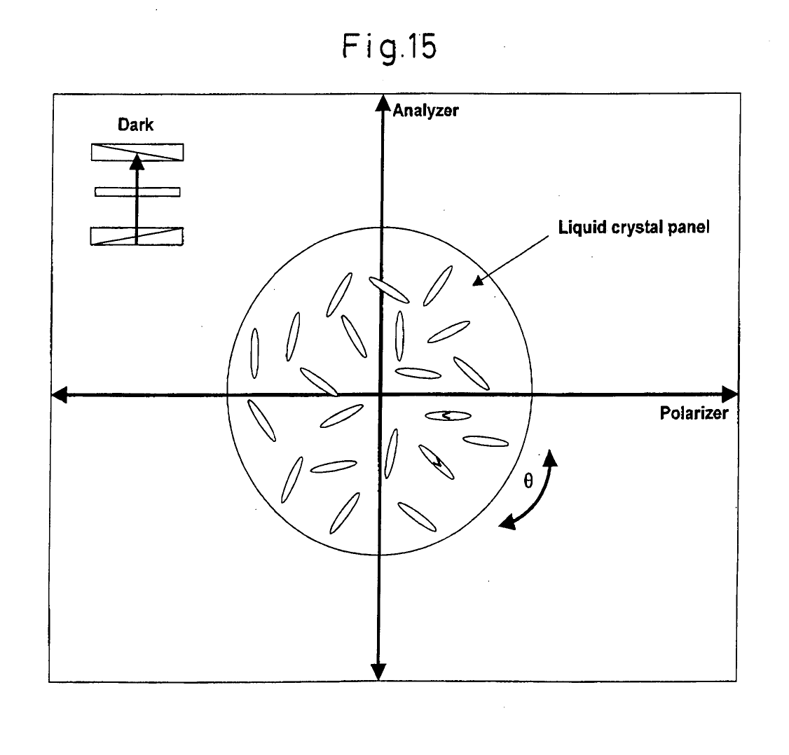

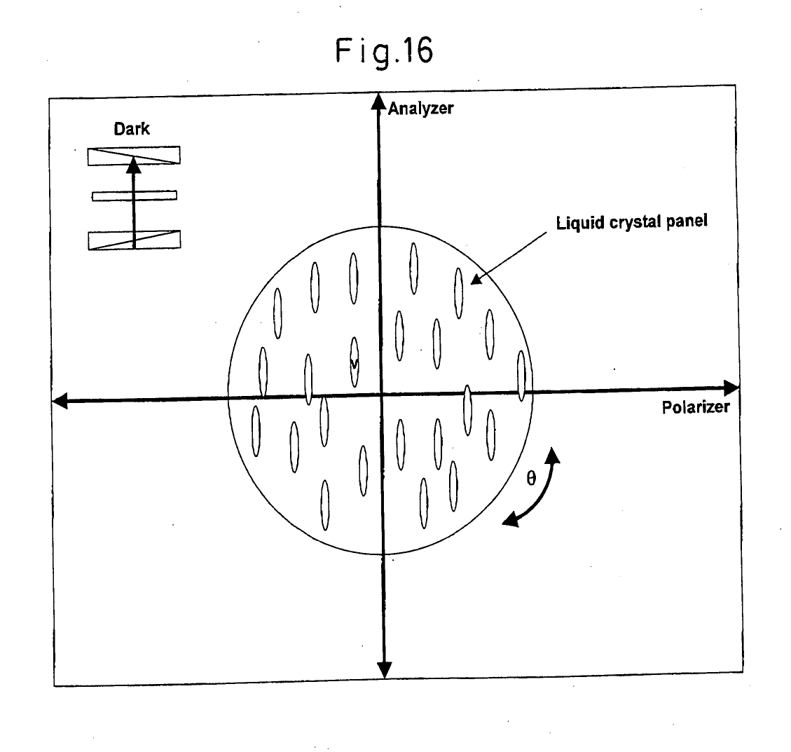

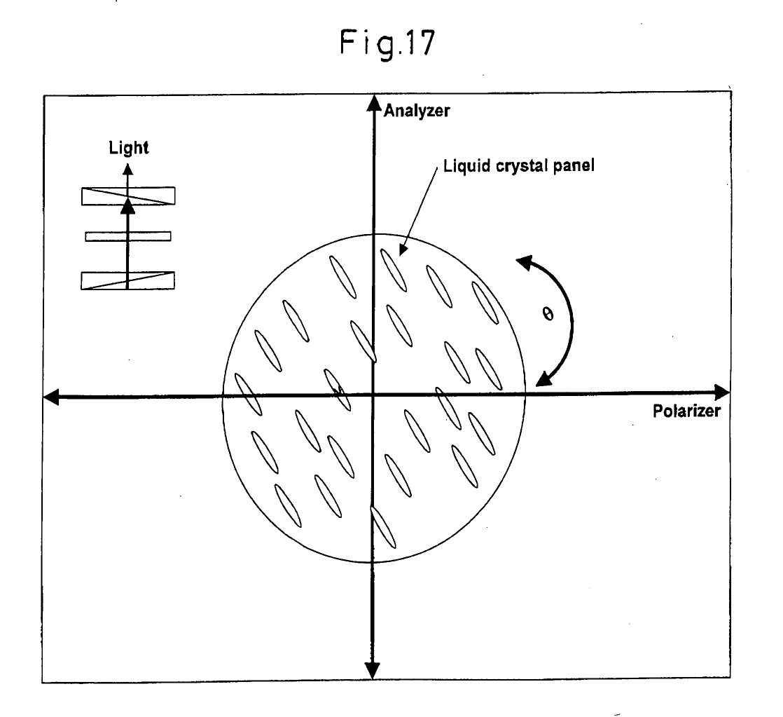

At the isotropic phase, directions of liquid crystal molecules are random, so that incident linearly polarized light passes through the liquid crystal panel straightforwardly, resulting in “dark” state as shown in FIG. 15 regardless panel angle to the incident light. By decreasing the ambient temperature, the liquid crystal goes into nematic phase or chiral nematic phase depending on achirality or chirarity of the liquid crystal. At the nematic phase, all of liquid crystals align their n-director to the pre-set alignment direction. In this situation, the liquid crystal panel does not allow the linearly polarized light passing through the analyzer due to no polarization rotation by the liquid crystal layer. Therefore, this shows “dark” state as long as the pre-set liquid crystal molecular alignment direction is parallel to the polarizer direction as shown in FIG. 16. Once, the liquid crystal panel is rotated, the incident linearly polarized light changes its polarization, resulting in light leakage as illustrated in FIG. 17.

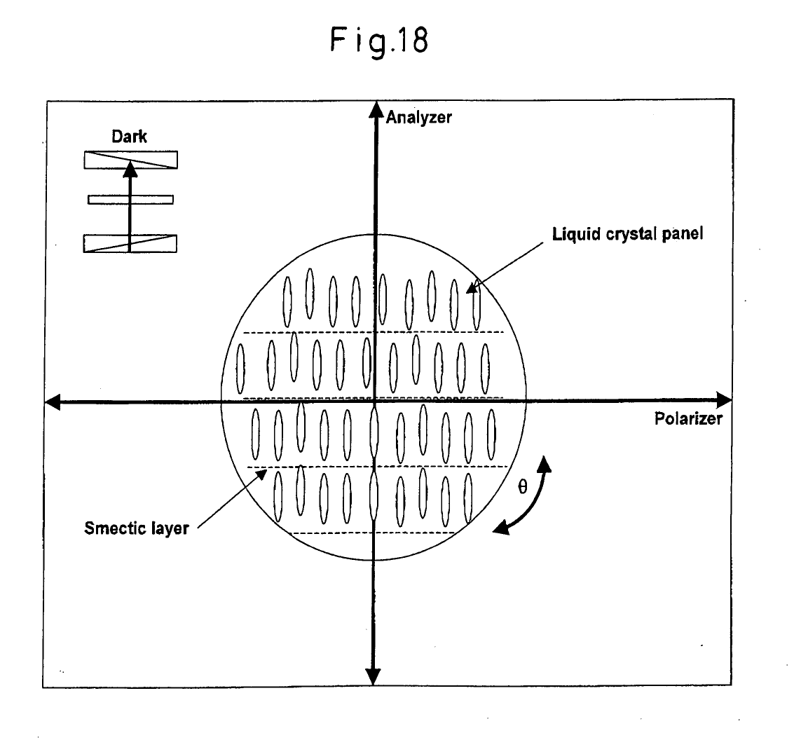

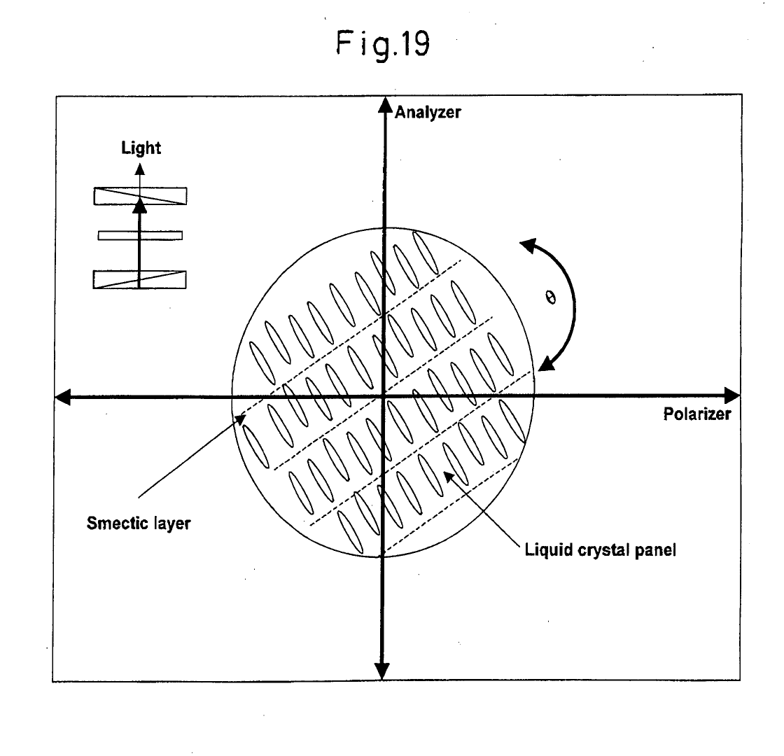

Further reduction of ambient temperature gives rise to next phase to the liquid crystal panel. The consequent liquid crystal phase is smectic A phase. Smectic A phase has a layer structure in its liquid crystal molecular configuration as illustrated in FIG. 18. This phase also allows incident linearly polarized light pass through the smectic liquid crystal layer straightforwardly, resulting in “dark” state. Like the nematic phase, the smectic A phase also shows some light leakage, when the panel is rotated shown in FIG. 19.

This consequent phase sequence is common with conventional smectic liquid crystals and the PSS liquid crystals. However, under the smectic A phase in terms of phase sequence along with ambient temperature, the light transmittance behavior is different between conventional smectic liquid crystals and the PSS liquid crystals.

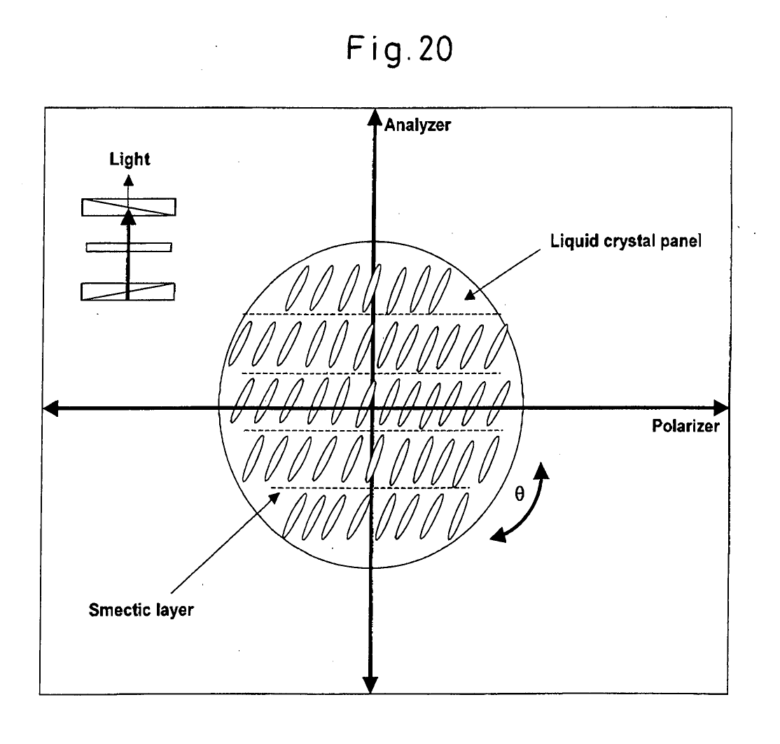

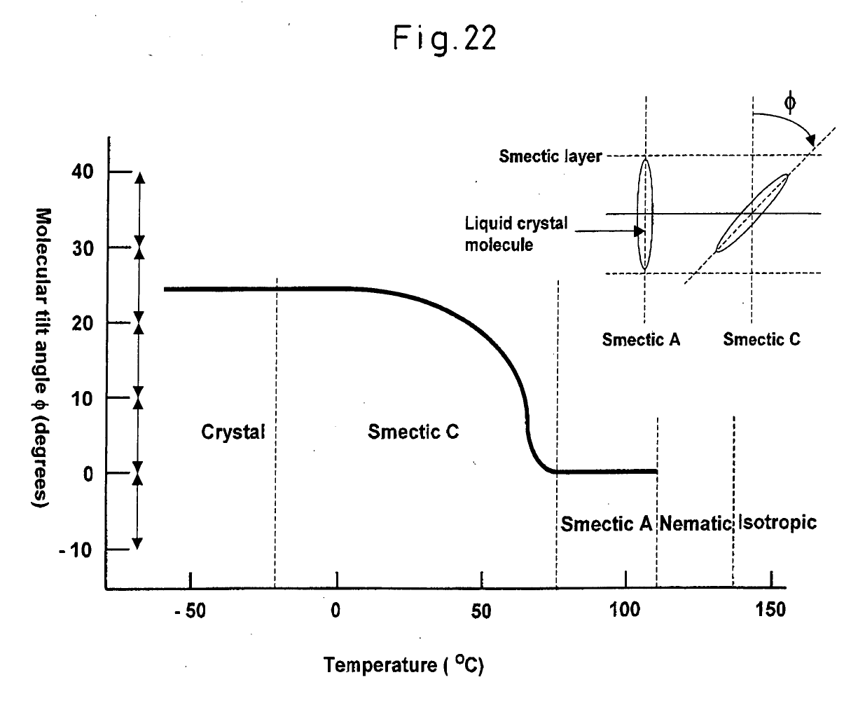

In the conventional smectic liquid crystals, next phase is smectic C phase or chiral smectic C phase, depending on its achirality or chirality as illustrated in FIG. 20. In the smectic C phase, n-director of the liquid crystal molecule tilts from the layer normal, resulting in “light leakage” state. The tilt angle is a function of ambient temperature with the second order phase change, which means the tilt angle gradually increases with decrease of ambient temperature as illustrated in FIG. 22. Therefore, the light intensity of the leaked light from the panel is dependent on ambient temperature. Until the molecular tilt angle saturates, the leaked light intensity increases in same profile with FIG. 22 in terms of increase of light intensity with the decrease of ambient temperature. This light leakage at the smectic C phase is the result of molecular tilt from the layer normal, which is quite common in conventional smectic C phase.

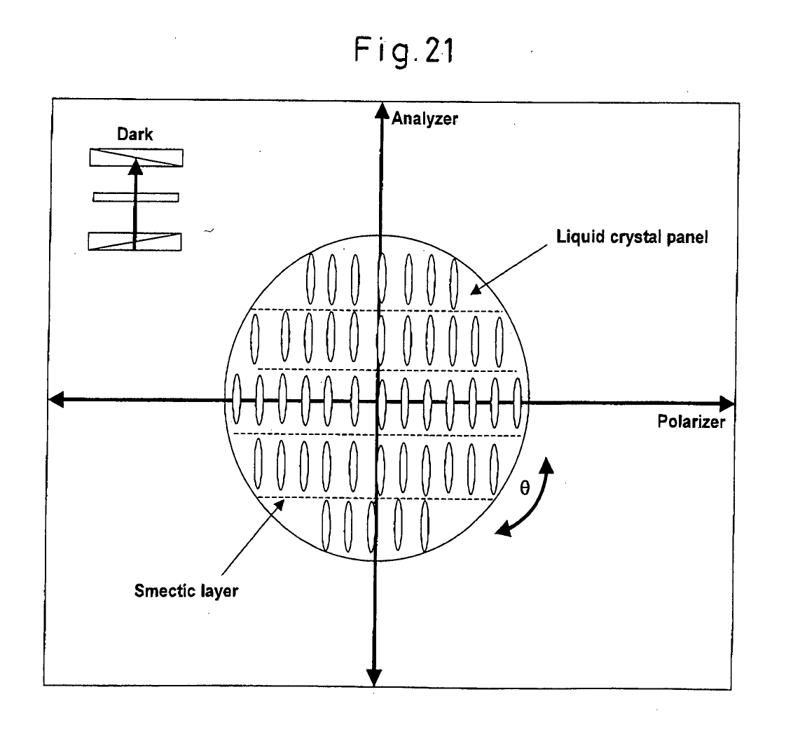

On the contrary, in the present invention which is the PSS-LC phase consequent to smectic A phase does not show the molecular tilt from the layer normal. In the PSS-phase, the n-director of the liquid crystal still keeps its direction normal to the layer. Therefore, the PSS phase does not show light leakage shown in the smectic C phase. Because of the PSS-LC's specific molecular direction, the light transmittance situation is same with that of smectic A phase in general as shown in FIG. 21.

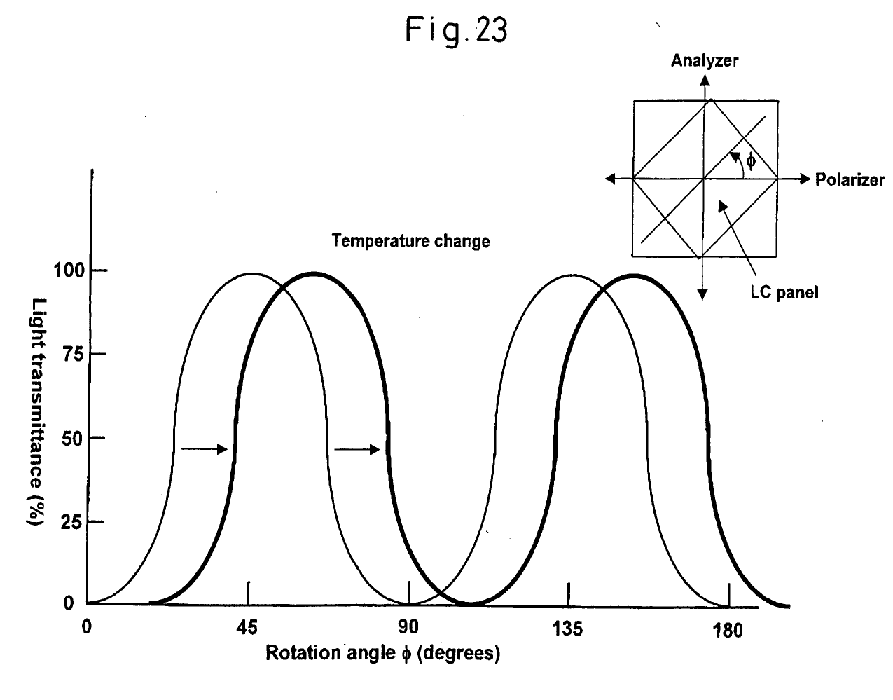

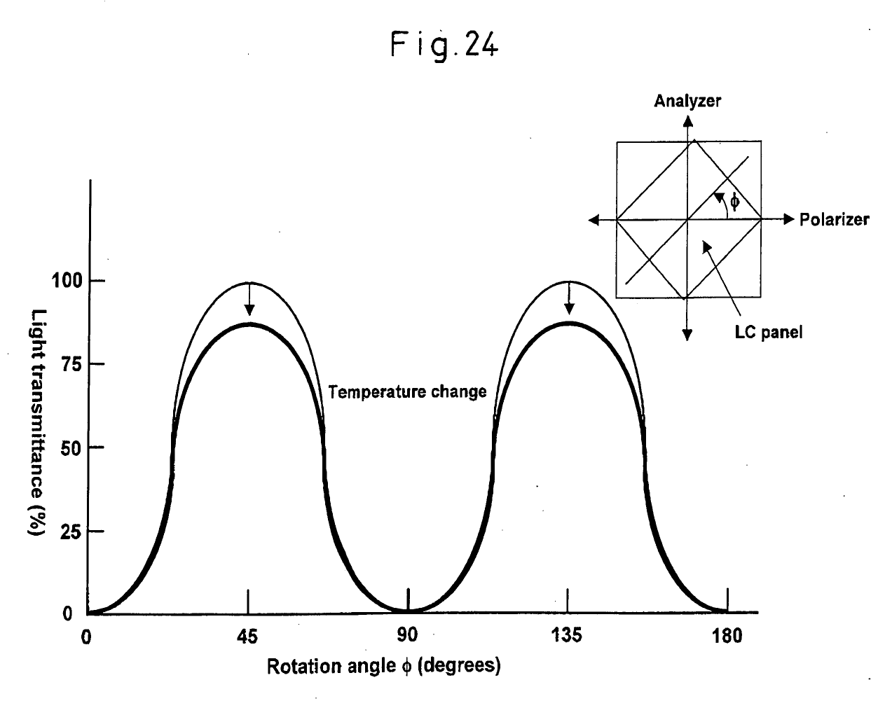

Since the difference in n-director direction between conventional smectic C phase and the PSS-LC phase, temperature dependence of the light intensity by rotation of the liquid crystal panel under the crossed Nicole is compared in FIGS. 23 and 24, respectively. Due to temperature dependent tilt angle of conventional smectic C phase, the extinction angle of the panel shifts depending on ambient temperature as shown in FIG. 23. Unlike the conventional LCD panel, the PSS-LCD does not show temperature shift in its extinction angle. The light intensity at “bright” state is dependent on ambient temperature, however, the extinction angle does not show any shift from its original angle as shown in FIG. 24.

Those Figures as clearly tell the difference between the conventional smectic C phase liquid crystals and the PSS-LCs in their optical situation.

(Difference Between Smectic C Phase and PSS-LC Phase)

There is another obvious visual difference differentiate conventional smectic C phase and the PSS-LC phase.

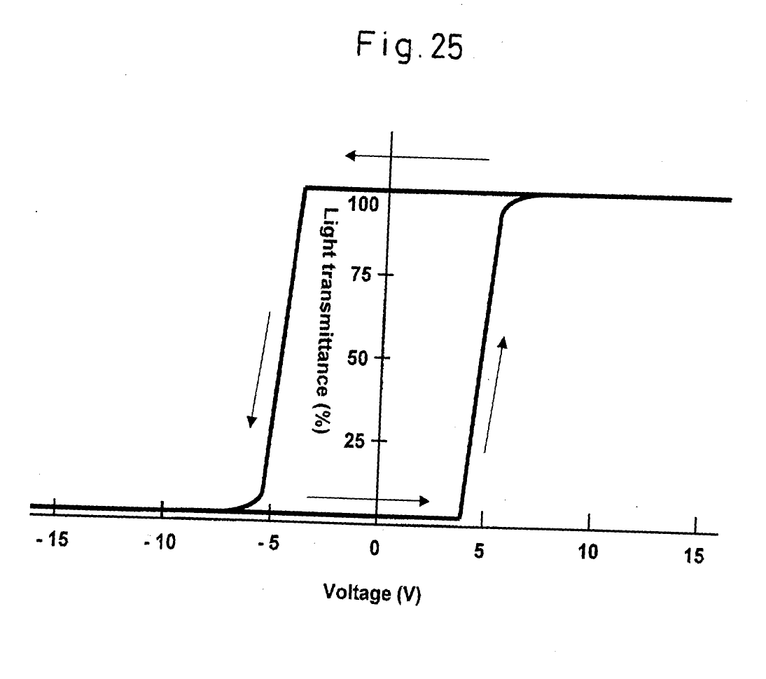

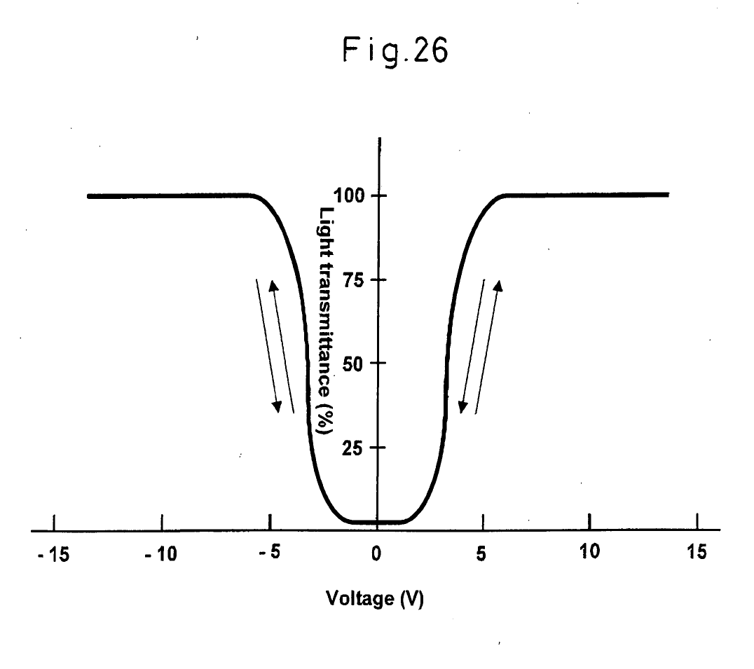

Due to the PSS-LCD performance, the voltage to transmittance curve (V-T curve) of the PSS-LCD is very different from that of conventional smectic C, or chiral smectic C phase. The dependence of applied electric field strength of the PSS-LCD presents an analog response V-T curve as shown in FIG. 25. In contrast, a conventional chiral smectic C phase liquid crystal display shows hysteresis in its V-T curve as illustrated in FIG. 26. Due to spontaneous polarization of the conventional chiral smectic C phase liquid crystal panel, its electro-optical response is dependent on the polarity of the applied voltage instead of the strength of the electric field. In short, the electro-optical response of the conventional chiral smectic C phase panel is not the applied electric field response, but the polarity response. In terms of electro-optical response, the PSS-LCD shows same optical response with nematic base LCDs whose electro-optical response is based on a coupling between the applied electric field and induced polarization of the liquid crystals.

Hereinbelow, the present invention will be described in more detail with reference to specific Examples.

### EXAMPLES

### Example 1

(Present Invention)

Home made Smectic C phase liquid crystal mixture material was prepared. The major molecular structures of the mixture are followings:

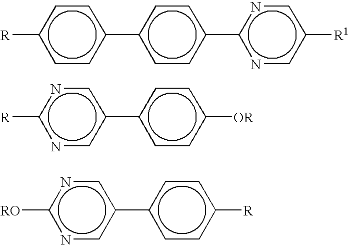

After the mixing, the phase sequence of the mixture was measured as bulk material by using “hot stage” (type: HCS 206) manufactured by Instec: Colorado corporation, and the polarized microscope manufactured by Nikon: Japanese corporation. The mixture shows Smectic C phase at the room temperature as a bulk shape. The Smectic C phase shows molecular director tilt from the Smectic layer normal, so that the extinction angle under the closed Nicole has some tilt from the layer normal.

Isotropic to Nematic: 92 deg.C., Nematic to Smectic A: 83 deg.C., Smectic A to Smectic C: 79 deg.C., Smectic C to Crystal: 13 deg.C. A sample panel was prepared and the i sample panel was filled with this mixture in the following manner.

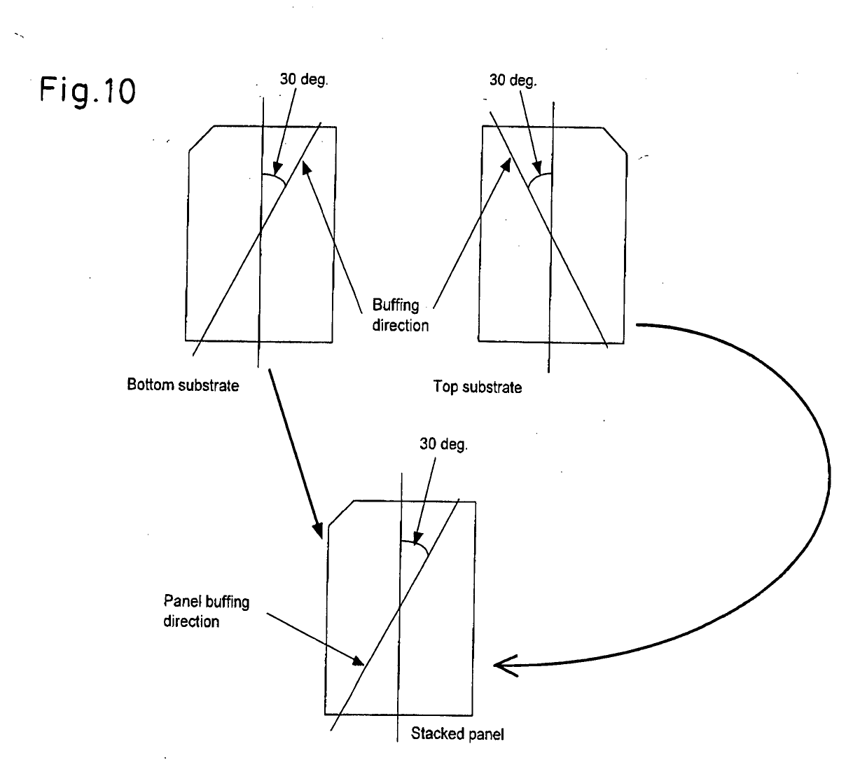

For liquid crystal molecular alignment material, RN-1199 (Nissan Chemicals Industries) was used as less than 1.5 degrees of molecular pre-tilt angle alignment material. Thickness of the alignment layer as cured layer was set at 800 A. The surface of this cured alignment layer was buffed by Rayon cloth in the direction of 30 degrees to center line of the substrate shown in FIG. 10. The contact length of the buffing cloth was set at 0.4 mm in both substrates of top and bottom.

Two buffed substrates were laminated with their buffing directions were parallel each other using silicon dioxide spacer balls with average diameter of 1.6 μm. Obtained panel gap as measured by using optical multiple reflection was 1.9 μm.

The above liquid crystal mixture was filled into the prepared panel at the isotropic phase temperature of 105 degree C. After the panel was filled with the mixture, ambient temperature was controlled to reduce 2 degrees C. per minute till the mixture showed the PSS phase near room temperature, which was 38 degrees C. Then, by natural cooling without control, after the panel temperature reached at room temperature, the panel was applied ±10 V, 500 Hz of triangular waveform voltage, 5 minutes. After 5 minutes voltage application, the panel was chipped off its liquid crystal fill hole.

The completed panel was measured in its phase sequence under the polarized microscope (Nikon) and Hot stage (Instec: type HCS 206). First, the panel temperature was increased up to 105 degrees C. by the Hot stage, then, the temperature was reduced at the rate of 1.5 degrees C. per minute. The panel showed phase transition from Isotropic to Nematic at 90.5 deg. C.; Nematic to Smectic A at 80.8 deg. C.; Smectic A to PSS at 72.3 deg. C.; and PSS to Crystal at 4 deg. C.

These different phase transition temperatures between bulk and panel were interpreted by super-cooling effect, which is widely observed phenomenon due to slow cooling rate. The distinguished fact is this panel satisfied with the PSS-LCD condition shows same extinction angle between Smectic A and the PSS phase. This is the specific characteristic property of the PSS-LCD.

This panel was also measured in its anisotropy of dielectric constant using Precision LCR meter (Agelent: type 4774) under the DC bias voltage of 6 V. The prove voltage of ±1 V; 1 kHz; rectangular waveform voltage was used. The measured anisotropy of dielectric constant was 2.3. This value is almost one third of averaged conventional LCDs. Therefore, this PSS-LCD panel provides much wider drive capability window compared to conventional LCDs.

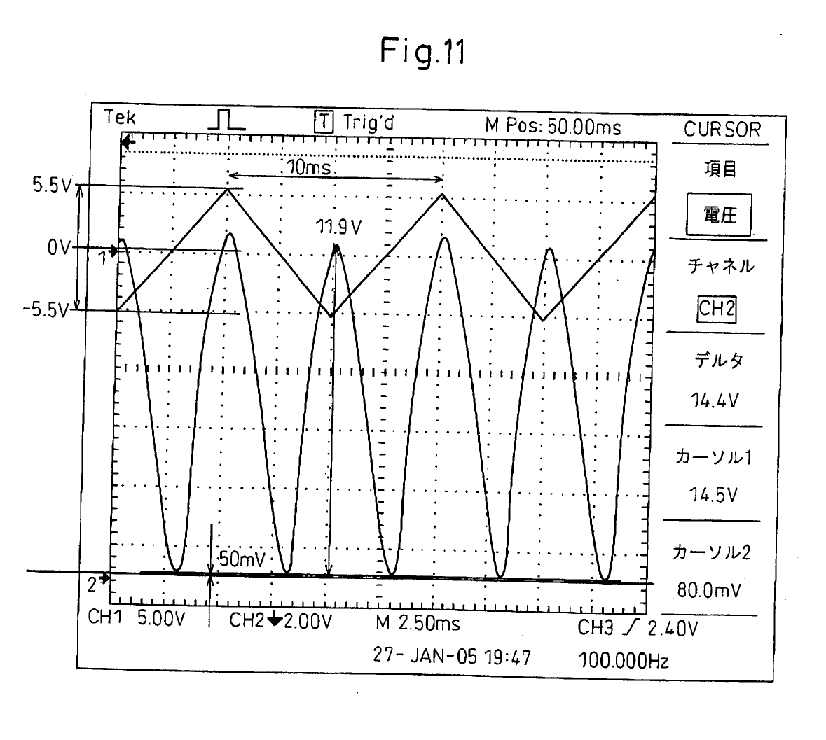

The electro-optical measurement of this panel showed analog gray scale by application of triangular waveform voltage as shown in FIG. 11. The most significant fact in terms of the effect of the present invention to the Smectic liquid crystal materials as bulk is that the invented liquid crystal molecular alignment effectively prevents the molecular directors from tilting to buffed angle at the PSS phase. This prevention of the molecular tilt at the Smectic C phase as a bulk is the intrinsic effect of the present invention. By preventing the molecular tilt under the certain panel condition, the analog gray scale with conventional liquid crystal driving method is enabled to show its superior performance.

### Example 2

### Control

Using Smectic A phase liquid crystal mixture shown its molecular formula below, a liquid crystal panel was fabricated.

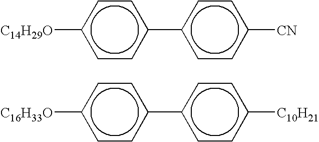

The liquid crystal shows Smectic A phase over 50 degrees C. as a bulk shape. The Smectic A phase shows molecular director no tilt from the Smectic layer normal, so that the extinction angle under the closed Nicole has no tilt from the layer normal. This liquid crystal has the phase sequence of Isotropic, Nematic, Smectic A, and Crystal.

For liquid crystal molecular alignment material, RN-1199 (Nissan Chemicals Industries) was used as less than 1.5 degrees of molecular pre-tilt angle alignment material. Thickness of the alignment layer as cured layer was set at 800 A. The surface of this cured alignment layer was buffed by Rayon cloth in the direction of 30 degrees to center line of the substrate shown in FIG. 10. The contact length of the buffing cloth was set at 0.4 mm in both substrates of top and bottom. Two buffed substrates were laminated with their buffing directions were parallel each other using silicon dioxide spacer balls with average diameter of 1.6 μm. Obtained panel gap as measured by using optical multiple reflection was 1.9 μm.

The above liquid crystal mixture was filled into the prepared panel at the isotropic phase temperature of 130 degree C. After the panel was filled with the mixture, ambient temperature was controlled to reduce 2 degrees C. per minute till the mixture showed Smectic A phase. Then, by natural cooling without control, after the panel temperature reached at 55 degrees C., the panel was applied ±10 V, 500 Hz of triangular waveform voltage, 5 minutes. After 5 minutes voltage application, the panel was chipped off its liquid crystal fill hole.

The panel showed phase transition from Isotropic to Nematic at 90.5 deg. C.; Nematic to Smectic A at 80.8 deg. C.; and Smectic A to Crystal at 4 deg. C.

This panel was measured in its anisotropy of dielectric constant using Precision LCR meter (Agilent: type 4774) under the DC bias voltage of 6 V. The prove voltage of ±1 V; 1 kHz; rectangular waveform voltage was used. The measured anisotropy of dielectric constant was 1.3. This value is almost one sixth of averaged conventional LCDs.

The electro-optical measurement of this panel showed no particular optical switching up to 20 V voltage. Due to too small anisotropy of dielectric constant with highly viscous Smectic A phase, this panel did not show any practical optical switching as a display. Because, this Smectic A phase has a coupling with externally applied electric field with its dipole-momentum. Using dipole-momentum, a practically effective coupling with applied electric field requires extremely large anisotropy of dielectric constant. However, large anisotropy of dielectric constant prevent TFT drivability from practical use.

### Example 3

### Control

Home made Smectic C phase liquid crystal mixture material was prepared. The major molecular structures of the mixture are followings:

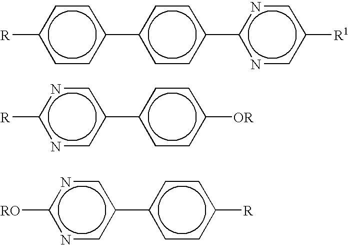

After the mixing, the phase sequence of the mixture was measured as bulk material by using “hot stage” (type: HCS 206) manufactured by Insteh: Colorado corporation, and the polarized microscope manufactured by Nikon: Japanese corporation. The mixture shows Smectic C phase at the room temperature as a bulk shape. The Smectic C phase shows molecular director tilt from the Smectic layer normal, so that the extinction angle under the closed Nicole has some tilt from the layer normal.

Isotropic to Nematic: 92 deg.C., Nematic to Smectic A: 83 deg.C., Smectic A to Smectic C: 79 deg.C., Smectic C to Crystal: 13 deg.C. This mixture was filled with the sample panel prepared as following.

For liquid crystal molecular alignment material, SE-610 (Nissan Chemicals Industries) was used as larger than 5 degrees of molecular pre-tilt angle alignment material. Thickness of the alignment layer as cured layer was set at 800 A. The surface of this cured alignment layer was buffed by Rayon cloth in the direction of 30 degrees to center line of the substrate shown in FIG. 10. The contact length of the buffing cloth was set at 0.1 mm in both substrates of top and bottom. Two buffed substrates were laminated with their buffing directions were parallel each other using silicon dioxide spacer balls with average diameter of 1.6 μm. Obtained panel gap as measured by using optical multiple reflection was 1.9 μm. The above liquid crystal mixture was filled into the prepared panel at the isotropic phase temperature of 105 degree C. After the panel was filled with the mixture, ambient temperature was controlled to reduce 2 degrees C. per minute till the mixture showed the PSS phase near room temperature, which was 38 degrees C. Then, by natural cooling without control, after the panel temperature reached at room temperature, the panel was applied ±10 V, 500 Hz of triangular waveform voltage, 5 minutes. After 5 minutes voltage application, the panel was chipped off its liquid crystal fill hole.

The completed panel was measured in its phase sequence under the polarized microscope (Nikon) and Hot stage (Instec: type HCS 206). First, the panel temperature was increased up to 105 degrees C. by the Hot stage, then, the temperature was reduced at the rate of 1.5 degrees C. per minute. The panel showed phase transition from Isotropic to Nematic at 90.5 deg. C.; Nematic to Smectic A at 82.2 deg. C.; Smectic A to Smectic C at 69.5 deg. C.; and Smectic C to Crystal at 2 deg. C. These different phase transition temperatures between bulk and panel were interpreted by super-cooling effect, which is widely observed phenomenon due to slow cooling rate. The distinguished fact is this panel does not satisfy the PSS-LCD condition. Therefore, this panel shows different extinction angle between Smectic A and Smectic C phase. This is different from the Example 5.1 here.

This panel was also measured in its anisotropy of dielectric constant using Precision LCR meter (Agilent: type 4774) under the DC bias voltage of 6 V. The prove voltage of ±1 V; 1 kHz; rectangular waveform voltage was used. The measured anisotropy of dielectric constant was 3.7. This value is almost half of averaged conventional LCDs. Therefore, this panel potentially provides wider drive capability window compared to conventional LCDs.

The electro-optical measurement of this panel showed no optical response. Because, this panel shows molecular n-director some tilt, this panel does not have any performance common with the PSS-LCD.

### Example 4

### The Present Invention

Home made Smectic C phase liquid crystal mixture material was prepared. The major molecular structures of the mixture are followings:

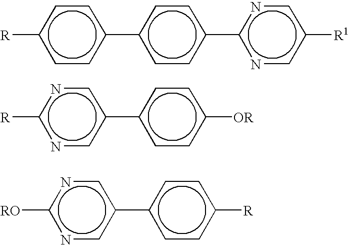

After the mixing, the phase sequence of the mixture was measured as bulk material by using “hot stage” (type: HCS 206) manufactured by Instec: Colorado corporation, and the polarized microscope manufactured by Nikon: Japanese corporation. The mixture shows Smectic C phase at the room temperature as a bulk shape. The Smectic C phase shows molecular director tilt from the Smectic layer normal, so that the extinction angle under the closed Nicole has some tilt from the layer normal.

Isotropic to Nematic; 92 deg.C., Nematic to Smectic A: 83 deg.C., Smectic A to Smectic C: 79 deg.C., Smectic C to Crystal: 13 deg.C. This mixture was filled with the sample panel prepared as following.

For liquid crystal molecular alignment oblique evaporation of silicon dioxide layer was used as less than 2 degrees of molecular pre-tilt angle alignment layer. Thickness of the alignment layer as average was set at 1200 A. Two substrates were laminated with their oblique evaporation directions were parallel each other using silicon dioxide spacer balls with average diameter of 1.6 μm. Obtained panel gap as measured by using optical multiple reflection was 1.9 μm. The above liquid crystal mixture was filled into the prepared panel at the isotropic phase temperature of 105 degree C. After the panel was filled with the mixture, ambient temperature was controlled to reduce 2 degrees C. per minute till the mixture showed the PSS phase near room temperature, which was 38 degrees C. Then, by natural cooling without control, after the panel temperature reached at room temperature, the panel was applied ±10 V, 500 Hz of triangular waveform voltage, 5 minutes. After 5 minutes voltage application, the panel was chipped off its liquid crystal fill hole.

The completed panel was measured in its phase sequence under the polarized microscope (Nikon) and Hot stage (Instec: type HCS 206). First, the panel temperature was increased up to 105 degrees C. by the Hot stage, then, the temperature was reduced at the rate of 1.5 degrees C. per minute. The panel showed phase transition from Isotropic to Nematic at 90.5 deg. C.; Nematic to Smectic A at 80.6 deg. C.; Smectic A to PSS at 72.0 deg. C.; and PSS to Crystal at 3.4 deg. C. These different phase transition temperatures between bulk and panel were interpreted by super-cooling effect, which is widely observed phenomenon due to slow cooling rate. The distinguished fact is this panel satisfied with the PSS-LCD condition shows same extinction angle between Smectic A and the PSS phase. This is the specific characteristic property of the PSS-LCD.

This panel was also measured in its anisotropy of dielectric constant using Precision LCR meter (Agelent: type 4774) under the DC bias voltage of 6 V. The prove voltage of ±1 V; 1 kHz; rectangular waveform voltage was used. The measured anisotropy of dielectric constant was 2.2. This value is almost one third of averaged conventional LCDs. Therefore, this PSS-LCD panel provides much wider drive capability window compared to conventional LCDs.

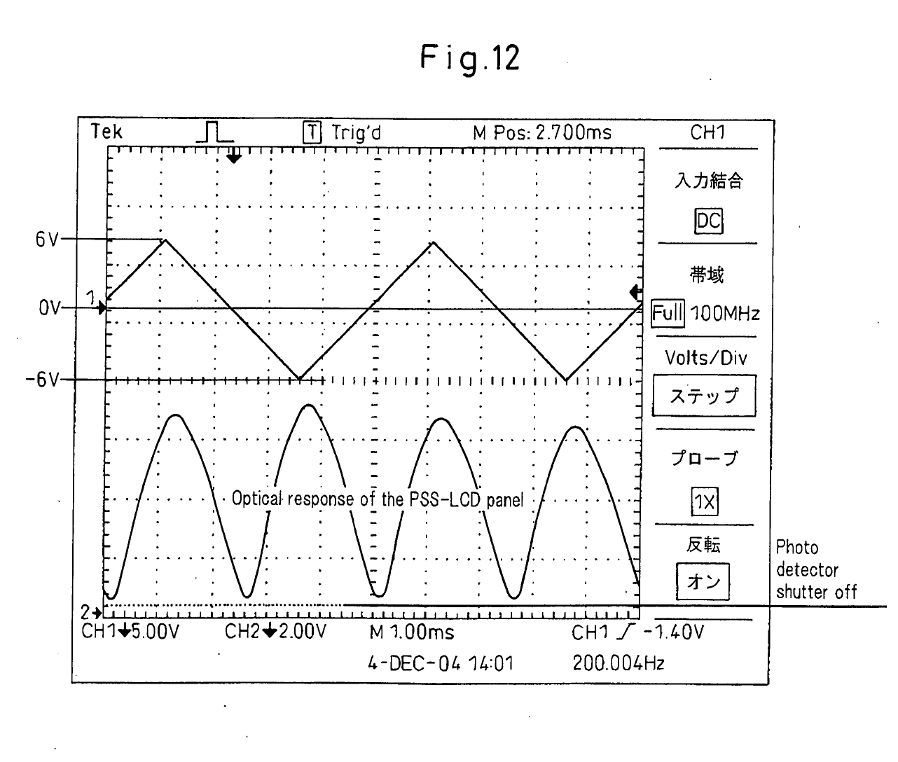

The electro-optical measurement of this panel showed analog gray scale by application of triangular waveform voltage as shown in FIG. 12. The most significant fact in terms of the effect of the present invention to the Smectic liquid crystal materials as bulk is that the invented liquid crystal molecular alignment effectively prevents the molecular directors from tilting to buffed angle at the PSS phase. This prevention of the molecular tilt at the Smectic C phase as a bulk is the intrinsic effect of the present invention. By preventing the molecular tilt under the certain panel condition, the analog gray scale with conventional liquid crystal driving method is enabled to show its superior performance.

### Example 5

### The Present Invention

Home made Smectic C phase liquid crystal mixture material was prepared. The major molecular structures of the mixture are followings:

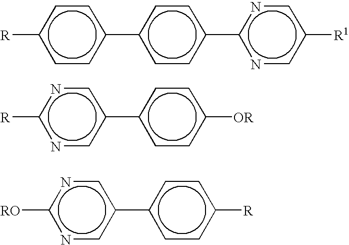

After the mixing, the phase sequence of the mixture was measured as bulk material by using “hot stage” (type: HCS 206) manufactured by Instec: Colorado corporation, and the polarized microscope manufactured by Nikon: Japanese corporation. The mixture shows Smectic C phase at the room temperature as a bulk shape. The Smectic C phase shows molecular director tilt from the Smectic layer normal, so that the extinction angle under the closed Nicole has some tilt from the layer normal.

Isotropic to Nematic: 92 deg.C., Nematic to Smectic A: 83 deg.C., Smectic A to Smectic C: 79 deg.C., Smectic C to Crystal; 13 deg.C. This mixture was filled with the sample panel prepared as following.

For liquid crystal molecular alignment, oblique evaporation of tantalum oxide layer was used as less than 2 degrees of molecular pre-tilt angle alignment layer. Thickness of the alignment layer as average was set at 1200 A. Two substrates were laminated with their oblique evaporation directions were parallel each other using silicon dioxide spacer balls with average diameter of 1.6 μm. Obtained panel gap as measured by using optical multiple reflection was 1.8 μm. The above liquid crystal mixture was filled into the prepared panel at the isotropic phase temperature of 105 degree C. After the panel was filled with the mixture, ambient temperature was controlled to reduce 2 degrees C. per minute till the mixture showed the PSS phase near room temperature, which was 38 degrees C. Then, by natural cooling without control, after the panel temperature reached at room temperature, the panel was applied ±10 V, 500 Hz of triangular waveform voltage, 5 minutes. After 5 minutes voltage application, the panel was chipped off its liquid crystal fill hole.

The completed panel was measured in its phase sequence under the polarized microscope (Nikon) and Hot stage (Instec: type HCS 206). First, the panel temperature was increased up to 105 degrees C. by the Hot stage, then, the temperature was reduced at the rate of 1.5 degrees C. per minute. The panel showed phase transition from Isotropic to Nematic at 90.5 deg. C.; Nematic to Smectic A at 80.6 deg. C.; Smectic A to PSS at 72.0 deg. C.; and PSS to Crystal at 3.4 deg. C. These different phase transition temperatures between bulk and panel were interpreted by super-cooling effect, which is widely observed phenomenon due to slow cooling rate. The distinguished fact is this panel satisfied with the PSS-LCD condition shows same extinction angle between Smectic A and the PSS phase. This is the specific characteristic property of the PSS-LCD.

This panel was also measured in its anisotropy of dielectric constant using Precision LCR meter (Agilent: type 4774) under the DC bias voltage of 6 V. The prove voltage of ±1 V; 1 kHz; rectangular waveform voltage was used. The measured anisotropy of dielectric constant was 2.7. This value is almost one third of averaged conventional LCDs. Therefore, this PSS-LCD panel provides much wider drive capability window compared to conventional LCDs.

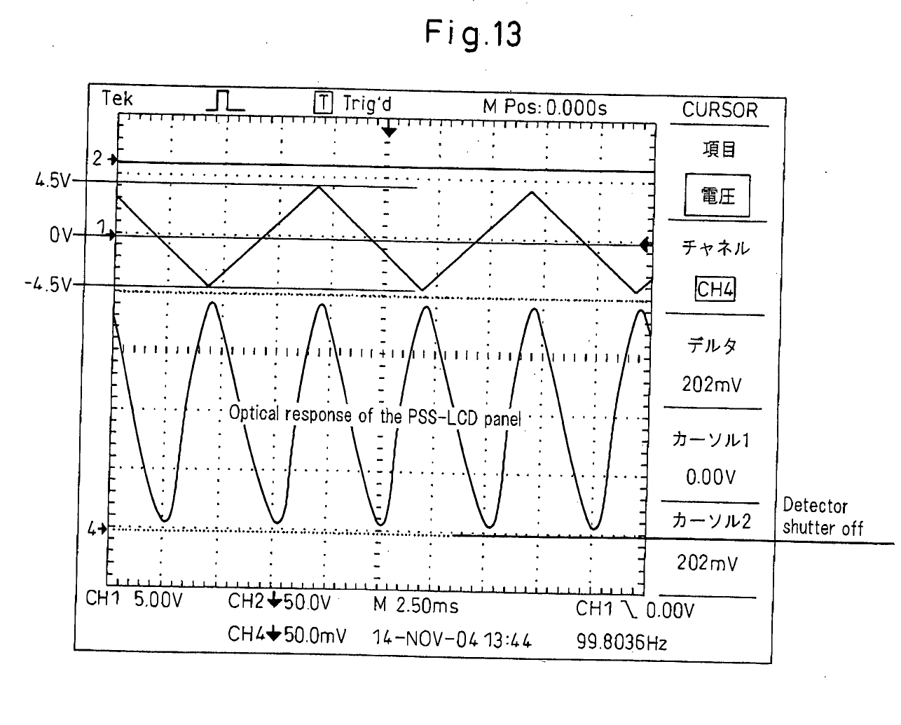

The electro-optical measurement of this panel showed analog gray scale by application of triangular waveform voltage as shown in FIG. 13. The most significant fact in terms of the effect of the present invention to the Smectic liquid crystal materials as bulk is that the invented liquid crystal molecular alignment effectively prevents the molecular directors from tilting to buffed angle at the PSS phase. This prevention of the molecular tilt at the Smectic C phase as a bulk is the intrinsic effect of the present invention. By preventing the molecular tilt under the certain panel condition, the analog gray scale with conventional liquid crystal driving method is enabled to show its superior performance.

(Comparison with Conventional Technology)

From above discussion and examples, in particular the description of preferred embodiment and the Examples, the present invention based on Polarization Shielded Smectic Liquid Crystal Displays (PSS-LCDs) has superiority to conventional TFT-LCDs, conventional SSFLCDs, and Polymer Stabilized V-shaped Ferroelectric Liquid Crystal Displays (PS-V-FLCDs) described in Japan Patent application number H09-174463 both in image quality performance and manufacturing cost for small high resolution displays and large screen direct view TVs.

(Effect of the Present Invention)

The present invention enables high quality image for large screen direct view TV with fast enough optical response at inter gray scale levels with less image blur by automatic shuttering effect using most of current existing large LCD panel manufacturing equipment with proven manufacturing process. This provides cost advantage in the manufacturing. The present invention also enables small screen with high resolution LCDs using field sequential color method, in particular for the advanced cell phone application. By using RGB LED backlight for field sequential color system, wider color saturation makes higher image quality in its color reproduction. This is extremely important for digital still camera monitor display which needs natural color reproduction.

Further, as described hereinabove, the present invention is based on analytical mechanism result and investigation of the quadra-pole momentum and its origin of liquid crystal molecules having specific molecular structure. Moreover, the present invention provides concrete method to produce high performance LCDs with reasonable manufacturing cost by detail investigation of previously reported the present inventor's technology: PSS-LCDs. The concept of the present invention, which is a specific liquid crystal molecular alignment, using the least symmetrical molecular structure, by strong azimuthal anchoring energy with weak polar anchoring energy, the natural molecular n-director having some tilt to the Smectic layer normal is effectively eliminated.

From the invention thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal device comprising: at least a pair of substrates; and
a Smectic phase liquid crystal material disposed between the pair of substrates,
wherein the molecular long axis or n-director of the Smectic phase liquid crystal material has a tilt angle to its layer normal as a bulk material, and the molecular long axis of the Smectic phase liquid crystal material aligns parallel to the pre-setting alignment direction, resulting in its long axis layer normal.

2. A liquid crystal device comprising: at least a pair of substrates; and
a Smectic phase liquid crystal material disposed between the pair of substrates,
wherein the molecular long axis or n-director of the Smectic phase liquid crystal material has a tilt angle to its layer normal as a bulk material, and
the liquid crystal device shows extinction angle along with the initial pre-setting alignment direction.

3. A liquid crystal device comprising: at least a pair of substrates; and
a Smectic phase liquid crystal material disposed between the pair of substrates, the Smectic phase liquid crystal material aligning its molecular long axis having a tilt angle to its layer normal as a bulk material,
wherein the molecular long axis of the Smectic phase liquid crystal material is forced to align to parallel to the pre-setting alignment direction, thereby making its molecular long axis normal to its layer.

4. A liquid crystal device according to any of claims 1-3 wherein the Smectic liquid crystal material shows its molecular long axis or n-director having a tilt angle to its layer normal as a bulk material.

5. A liquid crystal device according to any of claims 1-3, wherein the Smectic liquid crystal material is selected from the group consisting of: Smectic C phase materials, Smectic I phase materials, Smectic H phase materials, Chiral Smectic C phase materials, Chiral Smectic I phase material, Chiral Smectic H phase materials.

6. A liquid crystal device according to any of claims 1-3, wherein the surface of the substrates has a pre-tilt angle to the filled liquid crystal material of no larger than 5 degrees.

7. A liquid crystal device according to claim 3, wherein the surface of the substrates has a strong enough azimuthal anchoring energy to cause the molecular long axis of the Smectic phase liquid crystal material to align to parallel to the pre-setting alignment direction making its molecular long axis normal to its layer, and the azimuthal anchoring energy has been provided by mechanical buffing of a polymer layer.

8. A liquid crystal device according to claim 3, wherein the surface of the substrates has a strong enough azimuthal anchoring energy to cause the molecular long axis of the Smectic phase liquid crystal material to align to parallel to the pre-setting alignment direction making its molecular long axis normal to its layer, and the azimuthal anchoring energy has been provided by a polymer layer whose top surface has been exposed by polarized UV light.

9. A liquid crystal device according to claim 3, wherein the surface of the substrates has a strong enough azimuthal anchoring energy to cause the molecular long axis of the Smectic phase liquid crystal material to align to parallel to the pre-setting alignment direction making its molecular long axis normal to its layer, and the azimuthal anchoring energy has been provided by oblique evaporation of metal oxide material.

10. A liquid crystal device according to claim 9, wherein the oblique evaporation angle is no less than 7.0 degrees.

11. A liquid crystal device according to 9 or 10, wherein the evaporated metal oxide material is one selected from the group consisting of: SiO2, ZrO, Ta2O5, Cr2O3.
